(19) United States
(12) Patent Application Publication
(10) Pub. No.: US 2026/0074647 A1
(43) Pub. Date: Mar. 12, 2026

(54) Mechanisms for Moveable Solar Panel System

(71) Applicant: DoubleLand Corp, Berkeley, CA (US)

(72) Inventors: Gregory Rosen, Berkeley, CA (US); David Youmans, Mill Valley, CA (US)

(73) Assignee: DoubleLand Corp, Berkeley, CA (US)

(21) Appl. No.: 19/271,302

(22) Filed: Jul. 16, 2025

Related U.S. Application Data
(60) Provisional application No. 63/691,496, filed on Sep. 6, 2024.
(60) Provisional application No. 63/721,458, filed on Nov. 16, 2024.

(51) Int. Cl. H02S 20/32

(52) U.S. Cl. CPC H02S 20/32

(57) ABSTRACT

Aspects of this disclosure relate to multi-position solar panel arrays. Solar panel arrays may be configured for movement between regions that may allow for a dual use of land, such as for both agricultural production and electricity generation. In at least some examples, one or more wheel assemblies may be configured to removably attach to a frame of a solar panel array to facilitate lifting and/or movement of the solar panel array. A plurality of solar panel arrays may be configured for movement along a surface, such as along rails/tracks between pedestals, whereby the pedestals may be configured to: (1) secure solar panel arrays at fixed solar power generation locations, and (2) release the solar panel arrays to allow movement of the solar panel arrays between the pedestals. Additionally or alternatively, a plurality of solar panel arrays may be configured for movement along moveable connectors between connecting mechanisms located at the ends of the moveable connectors, whereby the connecting mechanisms may be configured to: (1) secure solar panel arrays at solar power generation locations, and (2) release the solar panel arrays to allow movement of the solar panel arrays between the connecting mechanisms when the solar panel arrays are not being used for solar power generation, and whereby the moveable connectors may be removed after movement of the solar panel arrays to facilitate increased access to land for agricultural purposes.

### CROSS-REFERENCE TO RELATED APPLICATIONS

This application claims the benefit of: U.S. Provisional Application No. 63/691,496, filed Sep. 6, 2024, and U.S. Provisional Application No. 63/721,458, filed on Nov. 16, 2024. The above referenced applications are hereby incorporated by reference in their entirety.

### TECHNICAL FIELD

Aspects described herein generally relate to photovoltaic energy systems for generating electrical power using solar panels. More specifically, aspects described herein relate to adaptation technologies in agriculture, including renewable energy solutions for agricultural applications.

### BACKGROUND

Solar panel systems are used in a variety of applications to generate electrical power. Power generated from solar panels and converted using related equipment, such as power optimizers, combiner boxes, and inverters, can be used locally at the place of generation, stored for future use with a battery, and/or supplied to the grid for use in other locations. Solar panels can be mounted onto the roof of a home or other building, or they can be installed on the ground such as in ground arrays. Agrivoltaic systems generally co-locate solar panel arrays with agricultural production, such that crops or livestock are located underneath or adjacent solar panels. Agrivoltaic systems are limited by a general inability to move solar panel arrays after installation, and as a result, land available for agricultural production is reduced with existing systems.

### SUMMARY

The following presents a summary in order to provide a general understanding of various aspects of the disclosure. The summary is not an exhaustive overview of the disclosure and is not intended to limit the scope of any inventive concepts described herein.

Aspects of this disclosure relate to systems and methods related to mechanisms for moveable solar panel systems. As described herein, solar panel arrays may comprise one or more rows, and may be configured for movement to various locations. The locations may include, but are not limited to, locations on a farm that may be used for growing crops and/or raising livestock. In addition to serving an agricultural purpose, the locations may serve a dual purpose of accommodating solar panel arrays for electrical power generation for at least some of the time. A plurality of solar panel arrays may be grouped and moved from a first location to a second location, or any number of locations, to allow for a dual use of land in a location for both agricultural production and electricity generation. For example, during a first time period that livestock are not grazing, a location may be covered by solar panel arrays; and, during a second time period that livestock are grazing, the solar panel arrays may be moved to another location to allow for such grazing. As another example, crops located in a first location and requiring a certain amount of sunlight may receive that sunlight while solar panel arrays are moved from the first location to a second location; and when the crops have received a sufficient amount of sunlight for a time period, the solar panel arrays may be moved back to the first location. As yet another example, when it is time to plant seeds in the first location and/or when crops are ready for harvesting in the first location, solar panel arrays located in the first location may be moved to the second location to allow for the planting of seeds and/or the harvesting of crops without having the solar panel arrays inhibit such processes. Mechanisms are described herein to facilitate case of movement of solar panel arrays using connected array frames and wheel assemblies for moveable solar panel systems which may advantageously enable greater use of land for both agricultural production and electricity generation. Additionally or alternatively, mechanisms are described herein to facilitate case of movement of solar panel arrays using moveable connectors as pathways for mobile solar panel mounting systems which may advantageously enable greater use of land for both agricultural production and electricity generation.

Systems and methods for moveable solar panel mounting systems as described herein may comprise a plurality of solar panel arrays, one or more frames, one or more wheel assemblies for moving the solar panel arrays, at least some electrical equipment that may be accessed from multiple locations to allow for the generation of electrical power via solar panel arrays from different locations, and (optionally) automated controls and/or sensors to assist in movement of one or more of the system and mechanisms described herein. Rails/tracks may be permanently or temporarily placed along the ground and generally along the sides of the plurality of solar panel arrays. A plurality of footings may be configured to secure the rails/tracks and/or to secure posts/legs of the array frames. Wheel assemblies may be provided for attachment to the array frames. The wheel assemblies may be removable. In some examples, pairs of wheel assemblies may be removed from connected array frames and attached to different connected array frames to facilitate movement of a plurality of connected array frames using a same set of wheel assemblies. A wheel assembly may comprise a bracket and one or more shafts. The bracket may at least partially enclose a wheel. The one or more shafts may be coupled to the bracket and may be configured to receive and/or be coupled to a lever to facilitate rotation of the wheel assembly. The wheel assembly may be configured with an attachment for connection to a post/leg of an array frame. After being attached to a post/leg of an array frame, and upon rotation of the wheel assembly in a first direction (e.g., via rotational and/or downward force upon the lever), the post/leg of the array frame may be raised from a ground surface to facilitate movement of the array frame. A plurality of wheel assemblies may be coupled to one or more (connected) array frames to facilitate their movement to/from different locations (e.g., along rails/tracks). In at least some examples, at least four wheel assemblies may be used, such that at least one wheel assembly may be located at each of four corners of a rectangular structure of one or more (connected) arrays. One or more mechanisms may be used to further facilitate movement of the solar panel arrays, such as a handle, tractor pull, motor, gear(s), pulley(s), cable(s), and the like. The mechanisms for moveable solar panel systems described herein provide a plurality of solar panel arrays in a solar power system that may be easily and quickly relocated between a plurality of locations, without relying upon permanent placement of wheel assemblies, thereby providing advantages such as reduced material costs, reduced exposure of wheel assemblies to weather elements, improved performance and/or product longevity, and/or increased dual-use access to land for agricultural and solar power generation purposes, as well as providing other advantages as evident from the descriptions herein.

Systems and methods for connecting mechanisms for mobile solar panel mounting systems as described herein may comprise a plurality of solar panel arrays, moveable connectors for moving the solar panel arrays, connecting mechanisms to secure the solar panel arrays when they are in solar power generation configurations and/or when they are not intended to be moved, at least some electrical equipment that may be accessed from multiple locations to allow for the generation of electrical power via solar panel arrays from different locations, and (optionally) automated controls and/or sensors to assist in movement of one or more of the system and mechanisms described herein. Moveable connectors may be temporarily placed along the ground and generally along the sides of the plurality of solar panel arrays. An adapter, or hoof, may be placed around a support of each solar panel array for fitting the solar panel arrays into a connecting mechanism. A base, or skate top, may be coupled to the hoof and/or the support of the solar panel array and may comprise one or more wheels on the underside to facilitate movement of the solar panel array along the moveable connector. The moveable connector may be configured for (temporary) attachment and/or securing to a pedestal upon which the base, or skate top, of the solar panel array may rest. One or more side portions may be attached to the pedestal to prevent lateral movement of the solar panel array. One or more brackets may be used to secure the solar panel array when not being moved from one location to another. One or more ballasts may be used, for example, as a counterweight to maintain positioning of the solar panel array in a manner that may counteract upward lift due to high wind conditions. The base, or skate top, may comprise one or more wheels or other moveable elements that may include a locking mechanism to prevent movement of the solar panel arrays during use when the wheels and/or other moveable elements are locked, and to allow movement of the solar panel arrays between locations when the wheels or other moveable elements are unlocked. One or more mechanisms may be used to further facilitate movement of the solar panel arrays, such as a handle, tractor pull, motor, gear(s), pulley(s), cable(s), and the like. The connecting mechanisms for mobile solar panel mounting systems described herein provide a plurality of solar panel arrays in a solar power system that may be easily and quickly relocated between a plurality of locations, without relying upon permanent pathways between the regions, thereby reducing material costs, improving flexibility in selection of locations for the solar panel arrays, and increasing dual-use access to land for agricultural and solar power generation purposes, as well as providing other advantages as evident from the descriptions herein.

These features and other features are described in greater detail below.

### BRIEF DESCRIPTION OF THE DRAWINGS

The present disclosure is shown by way of example figures, listed below, in which like reference numerals indicate similar elements.

FIG. 1 shows an example of a solar power system for use in a mobile solar panel system.

FIG. 2 shows an example of a moveable solar panel system.

FIG. 2A shows a portion of the moveable solar panel system of FIG. 2.

FIG. 2B shows a portion of the moveable solar panel system of FIG. 2.

FIG. 2C shows a portion of the moveable solar panel system of FIG. 2.

FIG. 3 shows an example of a moveable solar panel system.

FIG. 3A shows a portion of the moveable solar panel system of FIG. 3.

FIG. 3B shows a portion of the moveable solar panel system of FIG. 3.

FIG. 4 shows an example of a connected array carriage for a solar panel system.

FIG. 4A shows example components and a portion of the connected array carriage of FIG. 4.

FIG. 5A and FIG. 5B show different views of an example mounting structure for a frame and/or a rail of a moveable solar panel system.

FIG. 6A and FIG. 6B show different views of an example wheel assembly for a moveable solar panel system.

FIG. 7A and FIG. 7B show different views of an alternative example wheel assembly for a moveable solar panel system.

FIG. 8 shows example methods relating to moving a solar panel system.

FIG. 8A shows an example of attaching a wheel assembly to a solar panel system.

FIG. 8B shows an example of a wheel assembly lever attachment/insertion.

FIG. 8C shows an example of a rotation of a wheel assembly.

FIG. 8D shows an example of an end to rotation of a wheel assembly.

FIG. 8E shows an example of securing a wheel assembly to a solar panel system.

FIG. 9A shows an example of a moveable solar panel array system, located in a first position.

FIG. 9B shows an example of a moveable solar panel array system, located in a second position.

FIG. 10 shows an example of a solar panel array of a mobile solar panel array system.

FIG. 11A shows an example of a connecting mechanism, a moveable connector, and movement of a mobile solar panel array from one location to another location.

FIG. 11B shows an example of connecting mechanisms at opposite ends of solar panel arrays, moveable connectors, and movement of a plurality of mobile solar panel arrays.

FIG. 12A shows an example of a connecting mechanism to secure a frame of a mobile solar panel array.

FIG. 12B shows an example side view and top view of a portion of a connecting mechanism comprising an adapter, a base, and wheels.

FIG. 12C shows an example side view and top view of a portion of a connecting mechanism comprising ballasts and brackets.

FIG. 12D shows an example side view and top view of a portion of a connecting mechanism comprising a pedestal and side pieces.

FIG. 13A shows an example top view of a moveable connector.

FIG. 13B shows an example of a side view of a moveable connector.

FIG. 13C shows an example of a front/back view of a moveable connector.

FIG. 14 shows an example of an inter-row joiner for connecting a plurality of solar panel arrays.

### DETAILED DESCRIPTION

In the following detailed description, reference is made to the accompanying drawings, which form a part hereof, and in which is shown, by way of example, various embodiments in which aspects of the disclosure may be implemented. It is to be understood that other embodiments may be used, and structural and functional modifications may be made, without departing from the scope of the present disclosure. It is noted that various connections between elements are discussed in the following description. It is also noted that these connections are general and, unless specified otherwise, may be direct or indirect, wired or wireless, and that the specification is not intended to be limiting in this respect. In general, reference to connections herein that relate to power may be connections made via one or more wires, cables, conduits, and/or electrical connectors, not all of which may be shown in drawings but which would be readily understood by a person of ordinary skill in the art. The examples and arrangements described are merely some example arrangements in which the systems and methods described herein may be used. Various other arrangements employing aspects described herein may be used without departing from the invention.

As described above, agrivoltaic systems have been limited by a general inability to quickly and easily move solar panel arrays after installation. As a result, land available for agricultural production has been reduced with such systems. Additionally, at least some solar panel systems configured for movement may require either: permanent rails/tracks that may facilitate movement but that may also restrict at least some access and/or use of land that may be covered by moveable solar panel arrays, and/or components to facilitate movement that are costly, difficult, and/or time-consuming to use for moving solar panel arrays. Additionally or alternatively, at least some solar panel systems may not provide material benefits to the agricultural use(s) of the land such as flexibility in providing a wide range of sunlight, such as from no sun to full sun exposure. The present invention overcomes one or more of these deficiencies by providing methods, devices, and systems for moveable solar panel systems that may secure solar panel arrays to prevent their movement when configured for solar power generation and that may be connected in a carriage system to facilitate relatively quick and easy movement of solar panel arrays to different locations, whereby wheel assemblies may be disengaged and removed after the solar panel arrays have been moved to a desired location. In at least some examples described herein, these deficiencies may be overcome by providing methods, devices, and systems for connecting mechanisms for mobile solar panel systems that may secure solar panel arrays to prevent movement when configured for solar power generation and that may be coupled to one another, via moveable connectors, to facilitate movement of the solar panel arrays to different locations, whereby the moveable connectors may be disengaged and removed after the solar panel array has been moved to a desired location in order to improve access to land when not covered by solar panel arrays.

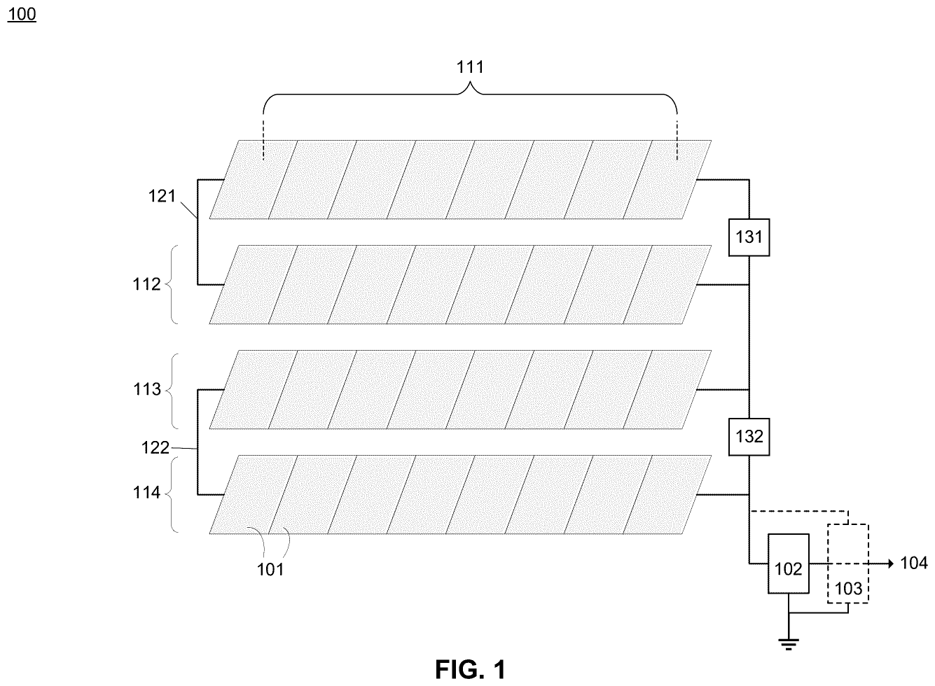

FIG. 1 shows an example of a solar power system. A solar power system 100 may comprise a plurality of solar panel arrays 111. Each solar panel array 111 may comprise a plurality of solar panels 101. Each solar panel 101 may comprise a plurality of solar cells (not shown) that may be used to convert sunlight into electrical power. While the solar panels 101 are shown as having a generally rectangular shape (e.g., from an angled view so as to otherwise appear to take a parallelogram shape), the solar panels 101 may comprise any shape, such as a rectangle, square, hexagon, etc. Each solar panel array 111 may be mounted on a frame or other mounting structure (not shown in FIG. 1), described and shown in further detail herein. The solar panels 101 may comprise a translucent material, such as in backless solar panels, which may enable growth of certain plants (e.g., cover crops) beneath the solar panels 101. As described herein, the frame (not shown) may comprise a moveable frame that may enable movement of the solar panel array 111 to/from different regions for solar power generation operation. Each solar panel array 111, and/or each solar panel 101 within a solar panel array 111, may be rotatable (e.g., per solar panel 101 and/or per solar panel array 111) along the frame, which may enable increased solar power generation such as by tracking (e.g., manually or automatically) the movement of the sun over the course of a day to help maintain positioning of the solar panels 111 relative to the sun in an effort to maximize electrical production.

One or more solar panels 101 may be coupled to a power optimizer (not shown), or other electrical equipment, that may be mounted on the underside of the respective panel(s) or on an adjacent structure upon which the respective panel(s) may be mounted, and that may operate to deliver a desired power level. The system 100 may comprise a plurality of power optimizers (e.g., one or more per solar panel, one or more per solar panel array, etc.). For example, each solar panel 101 may generate different amounts of electrical power based on various factors such as relative positioning, angle, amount of sun exposure and/or shading, and/or physical characteristics of the panel. A power optimizer may operate as a direct current (DC)-to-DC converter for the solar panel(s) 101 by using maximum power point tracking (MPPT) across a plurality of panels to monitor and adjust DC characteristics of each panel in a manner that may help maximize overall energy output of a plurality of solar panels 101.

While FIG. 1 shows four sets of solar panel arrays 111, 112, 113, and 114, the solar power system 100 may comprise any quantity of solar panel arrays 111 (e.g., less than four—such as one, two, or three—or more than four—such as six, twelve, twenty-four, one-hundred, one-thousand, etc.). For clarity, element number 111 is used interchangeably herein to refer to a solar panel array in the singular form and in the plural form, depending on context within the description. For example, in the singular form, the solar panel array 111 may be one of a plurality of solar panel arrays that also includes solar panel array 112, solar panel array 113, and/or solar panel array 114. In this singular form, reference to one or more features of the solar panel array 111 may apply similarly to each of the other solar panel arrays in the solar power system 100 (e.g., each of the solar panel arrays 112, 113, and/or 114). In the plural form, each of the solar panel arrays of the solar power system 100 may be referred to collectively as a plurality of solar panel arrays 111 (e.g., comprising all of solar panel arrays 111, 112, 113, and 114). In at least some examples, two or more solar panel arrays (e.g., 113 and 114; or 111 and 112) may be mounted to the same frame or otherwise may be physically connected to each other via an inter-row joiner and/or one or more other structure(s). These connected solar panel arrays may be referred to herein as a carriage or a connected array carriage.

While FIG. 1 shows eight solar panels 101 in each solar panel array 111, any of the solar panel arrays 111 may comprise any quantity of solar panels 101 (e.g., less than eight—such as two, three, four, etc.—or more than eight—such as ten, twelve, twenty-four, one-hundred, one-thousand, etc.). One or more solar panel arrays 111 may comprise the same quantity of solar panels 101, or a different quantity of solar panels 101, as any of the other solar panel arrays 111.

Solar panel arrays 111 may be connected in series or in parallel via one or more connections. For example, solar panel array 111 may be coupled to solar panel array 112 via a connection 121 and/or via a connection element 131. A connection element 131 may comprise one or more of a disconnect, a combiner box, and/or other electrical equipment. Solar panel array 113 may be coupled to solar panel array 114 via a connection 122 and/or via a connection element 132. A connection element 132 may comprise one or more of a disconnect, a combiner box, and/or other electrical equipment. A plurality of solar panels 101 in a solar panel array 111 may be grouped as a string of solar panels. A string of solar panels may be coupled to other solar panels, for example, via an AC disconnect, a DC disconnect, and/or any combination of disconnects. A solar panel array 111 may comprise any combination of rows of solar panels. For example, while FIG. 1 shows a single row of solar panels as a solar panel array 111, the solar panel array 111 may comprise more than one row of solar panels (e.g., two, three, four, or as many rows as may be included in the solar power system 100.

The connection(s) 121 and/or 122 may comprise electrical wiring, cables, and/or electrical conduit through which electrical wire(s)/cable(s) may pass. The connection elements 131 and/or 132 may comprise one or more electrical components that may be used to combine the electrical output of a plurality of solar panels 101 into a combined electrical output. The one or more electrical components may comprise, for example, one or more circuit breakers such as DC molded case circuit breakers (MCCB), one or more fuses such as photovoltaic (PV) string fuses, one or more electrical junctions for coupling wiring/cabling, and the like. The connection elements 131 and/or 132 may be mounted on a frame (not shown) of the solar panel array 111. Output(s) of the connection elements 131 and/or 132 may provide the combined electrical output of the solar panels 101 into an inverter 102. The inverter 102 may convert the combined electrical output of the solar panels 101 from DC into alternating current (AC). For example, an output 104 of the inverter 102 may comprise 120 volts (V) AC and/or 240 VAC. Optionally, the solar power system 100 may comprise a battery 103, such as a battery energy storage system (BESS). The battery 103 may usAC coupling and/or DC coupling to store power and provide electricity at a later time, such as during a time that the solar panels 101 may not be generating electricity (e.g., during evening, weather events, power outage, etc.). For example, the battery 103 may use DC coupling by storing power in the form of DC received from the combined electrical output from the connection elements 131 and/or 132 (e.g., as shown in dashed line output from the connection elements 131 and/or 132 and input to the battery 103). Additionally or alternatively, the battery 103 may use AC coupling by storing power received from the inverter 102 (e.g., in AC) after converting the AC back to DC for storage. The battery 103 may optionally comprise an inverter for converting DC power to AC (e.g., in an AC coupling configuration) to provide the output 104 of the solar power system 100. While the solar power system 100 is shown in a configuration using the inverter 102 as a central inverter, additionally or alternatively, one or more microinverters (not shown) may be used in the solar panel system 100, such as in place of the inverter 102 (e.g., which may be replaced by a large combiner box combined with the one or more microinverters). Additionally or alternatively, the inverter 102 may comprise a plurality of inverters that may be spaced apart from each other, such as to be closer to a particular one or more location, as described further herein.

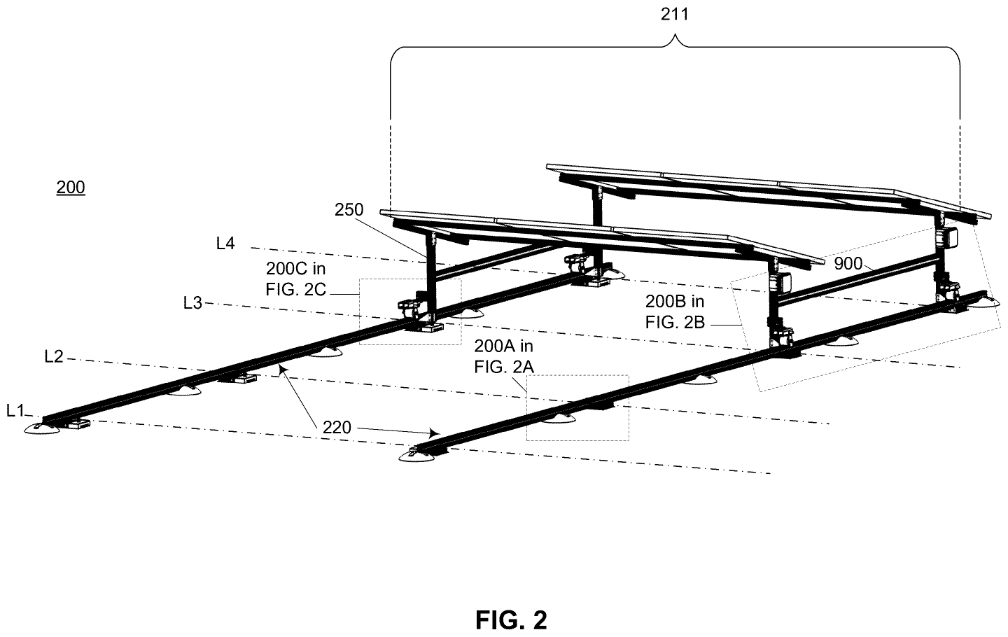

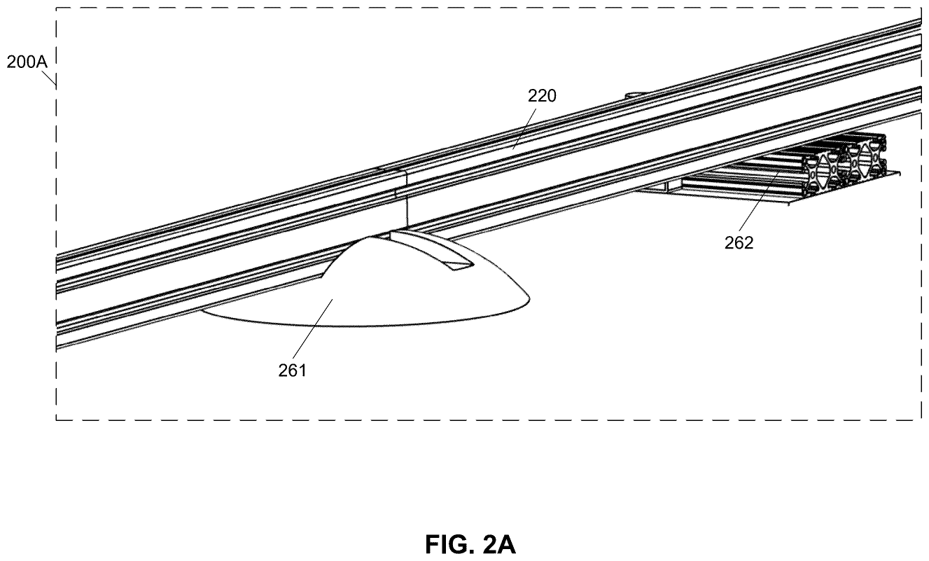

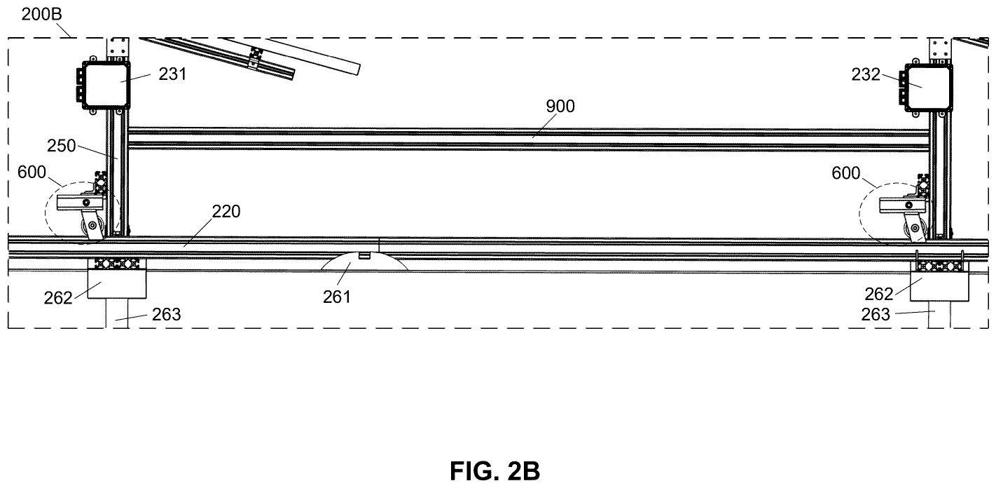

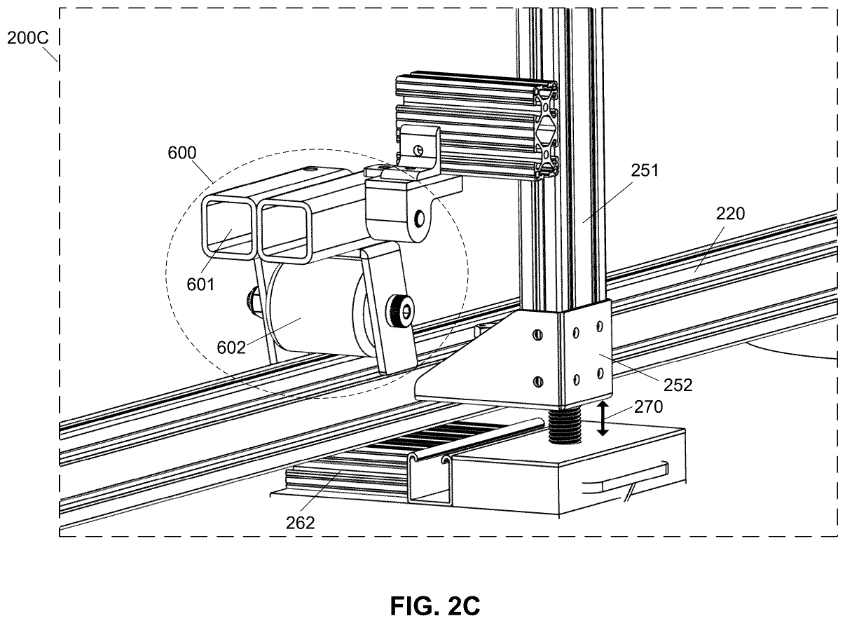

FIG. 2 shows an example of a moveable solar panel system. A moveable solar panel system 200 may comprise one or more solar panels and one or more rails/tracks 220. Reference herein to “rail 220,” “rail,” and/or “rail(s)/track(s)” may refer to one or more of a rail, a track, and/or any structure configured to provide a pathway for a moveable solar panel system. While an example of a rail is shown as rail 220 in FIG. 2, the moveable solar panel system described herein may be used with any other structure corresponding to a rail. For example, while only two rails 220 are shown in FIG. 2, the system 200 may comprise any number of rails 220, such as three or more rails 220 wherein at least one of the three or more rails may be located in between two outer rails 220 shown in FIG. 2. As another example, while the rails 220 in FIG. 2 are shown as being parallel (or substantially parallel) relative to each other, one or more additional rails (not shown) may be arranged to be perpendicular to the rails 220 shown in FIG. 2. Such one or more perpendicular rails may provide for movement in a direction perpendicular to the two rails 220 shown in FIG. 2. The one or more solar panels may correspond to one or more arrays of solar panels, and reference herein to solar panel array(s) 211 may refer to these one or more solar panels of the moveable solar panel system 200. A solar panel array 211 may be configured to be moveable between a plurality of locations. In at least some examples, the solar panel array 211 may be configured to be moveable to any location, and may not be limited to a specific number of fixed locations. FIG. 2A, FIG. 2B, and FIG. 2C each shows a portion of the moveable solar panel system of FIG. 2 corresponding to areas 200A, 200B, and 200C, respectively, in FIG. 2.

The solar panel array 211 in FIG. 2 may correspond to a solar panel array of the plurality of solar panel arrays 111 described with respect to FIG. 1. Any of the features with respect to the solar panel system 100 described and/or shown with respect to FIG. 1 may correspond to elements of FIG. 2. For example, a connection element 231 and/or a connection element 232 (shown in 200B in FIG. 2B) may correspond to the connection element 131 and/or the connection element 132 described with respect to FIG. 1. At least one of the connection elements 231 and/or 232 may be electrically coupled to the inverter 102 and/or the battery 103 shown and described with respect to FIG. 1. A frame 250 may correspond to a moveable frame such as described (but not shown) with respect to FIG. 1. In at least some examples, such as if attached to one or more wheels and/or wheel assemblies, the frame 250 may be a moveable frame. In at least some other examples, such as if not attached to one or more wheels and/or wheel assemblies, the frame 250 may be a stationary frame. For example, reference herein to “moveable frame” may refer to the frame 250 that may be configured with one or more wheels and/or one or more wheel assemblies. As another example, reference herein to “frame” may refer to the frame 250 that may be configured with or without one or more wheels and/or the frame 250 that may be configured with or without one or more wheel assemblies. The frame 250 may connect a plurality of solar panel arrays as a single/connected structure, which may be referred to herein as a connected frame, a connected array frame, a carriage, and/or a connected array carriage.

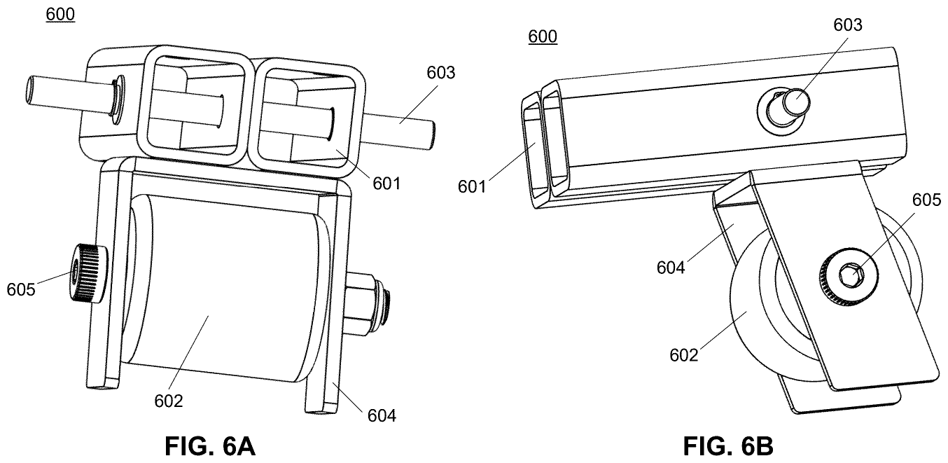

The frame 250 may be configured for attachment of one or more wheel assemblies 600, shown in FIG. 2B and in more detail in FIG. 6A and FIG. 6B described further herein. The one or more wheel assemblies 600 may correspond to one or more wheels and/or friction reducing element(s) as described herein. One or more of the wheel assemblies 600 may comprise a wheel lock and/or movement resistive element (not shown). The wheel lock may be configured to resist movement of the moveable frame 250, for example, when the wheel lock is engaged. The wheel lock may be configured to disable resistance of movement of the moveable frame 250, for example, when the wheel lock is disengaged.

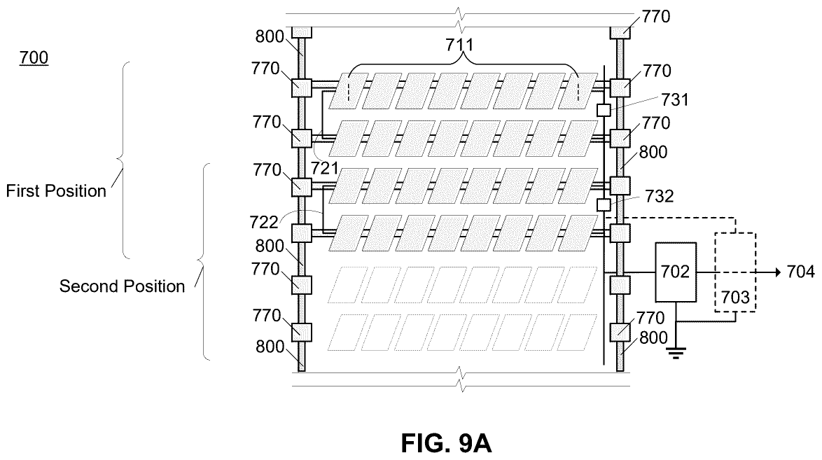

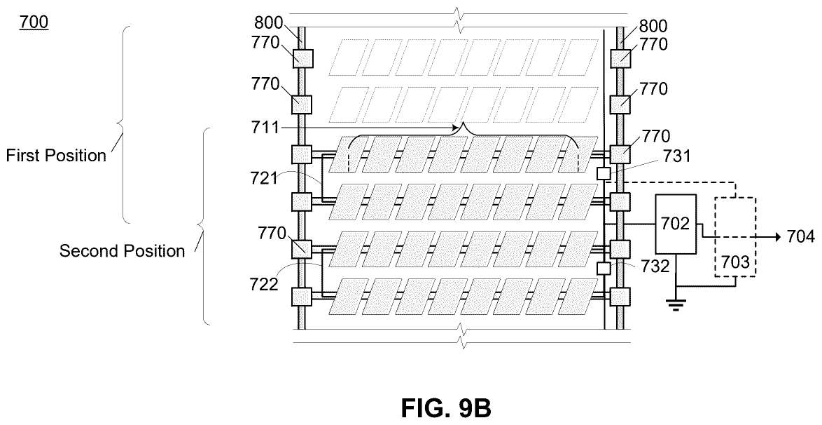

The wheel assemblies 600 may facilitate movement of the solar panel array 211 along rails 220 (e.g., forward and/or backward) that may be (temporarily or permanently) installed along the ground for movement of the solar panel array 211 between different locations for solar power generation. In at least some examples, the wheel assemblies 600 may be configured to be rotatable such as to allow movement in lateral directions. For example, lateral rails (not shown) may be used and configured to be perpendicular to the rails 220 shown in FIG. 2 (e.g., in a grid-like configuration with a first set of parallel rails, such as the rails 220 shown, being perpendicular to one or more second (set of) rail(s)), whereby, upon rotation of the wheel assemblies 600 (e.g., by plus or minus 90-degrees, or by plus or minus 270 degrees) the solar panel array 211 may be moved in a lateral direction (e.g., to the left or to the right) perpendicular to the rails 220 shown in FIG. 2. As another example, the solar panel array 211 may be moved (either separately or in combination with movement of a plurality of solar panel arrays) in a direction parallel to the rails 220 shown in FIG. 2 so as to be located in a first position (such as shown and described herein with respect to FIG. 9A regarding a plurality of solar panel arrays 711 that may correspond to the solar panel arrays 211), that may cover an area between lines L3 and L4 and rails 220 in FIG. 2. The solar panel array 211 may be moved to any other position(s) such as a second position (such as shown and described herein with respect to FIG. 9B regarding a plurality of solar panel arrays 711 that may correspond to the solar panel arrays 211), that may cover an area between lines L2 and L3 in FIG. 2. The solar panel arrays 211 may be moved to any other position (e.g., N^{th} position, that may cover an area to the left of line L2 such as an area covering between lines L1 and L2 in FIG. 2. Each solar panel array 211 may be moved, for example, after installing rails 220 between locations to/from which the solar panel array 211 is to be moved, after attaching respective wheel assemblies 600 to the moveable frame 250, and after disconnecting all wiring/cables that couple the respective solar panel array 211 to a respective connection element 231 and/or 232 (e.g., wire coupling the connection element 231 and/or 232 to an inverter such as the inverter 102 described with respect to FIG. 1). These steps may be performed in any order. For example, disconnecting all wiring/cables may be recommended as an initial step.

As shown in FIG. 2, the solar panel array 211 may comprise any quantity of solar panels. As an example, three solar panels are shown in each solar panel array 211 in FIG. 2, with two pairs of arrays mounted to the same moveable frame 250. The moveable frame 250 may comprise an inter-row joiner 900, shown in more detail in FIG. 2B, that may connect the two pairs of arrays 211 together such that the connected arrays 211 move together via movement of the moveable frame 250. The inter-row joiner 900 may be used for connecting any plurality of solar panel arrays 211. For example, the inter-row joiner 900 may comprise a structure that is configured to couple two or more rows of solar panel arrays so that they may be moved together (e.g., using a same force to move the rows of solar panel arrays connected by the inter-row joiner 900). The inter-row joiner 900 may be made of any material, such as metal, plastic, composite material, and the like. In at least some examples, the inter-row joiner 900 may comprise a same or similar material as the moveable frame 250. While FIG. 2 shows the inter-row joiner 900 connecting two solar panel arrays 211, any quantity of solar panel arrays may be connected to one or more inter-row joiners 900. The inter-row joiner 900 may be modified for any size and/or shape to accommodate the respective quantity of solar panel arrays 211 to be connected. An additional example of an inter-row joiner 9900 is shown in FIG. 14, which may also or alternatively be used as the inter-row joiner 900.

The solar panel array 211 may comprise fewer than, or greater than, the three solar panels shown in FIG. 2. The solar panels of the solar panel array 211 may be mounted on the moveable frame 250 of the solar panel array 211 by any mounting mechanism (e.g., mounting bars, clips, beams, etc.). Solar panel configurations for the solar panel array 211 may be customized based on site requirements. For example, solar panel configurations may range from completely horizontal (e.g., zero degree tilt), a 15-degree title angle, a 20-degree tilt angle, and/or a 30-degree tilt angle (or any other tilt angle). Additionally or alternatively, the solar panel array 211 may have its solar panels configured as trackers (e.g., facing east in the morning and slowly rotating west over the course of the day to track the location of the sun). Solar panels in the solar panel array 211 may be spaced anywhere relative to each other, such as from less than an inch apart to one or more feet apart (or any other distance), for example, to allow for structural considerations such as wind load, and/or to accommodate the total amount of direct sunlight that may fall on the land beneath the panels (e.g., to help enable certain crop and/or grass/feed growth).

In addition to the wheel assemblies 600, or in the alternative to the wheel assemblies 600, the moveable frame 250 described with respect to FIG. 2 may comprise one or more friction reducing elements for facilitating movement of a plurality of solar panel arrays 211 between a first location (e.g., first position) and at least a second location (e.g., second position and/or N^{th} position). In at least some examples, the friction reducing element(s) may comprise a plurality of rolling elements. The plurality of rolling elements may comprise sliding brackets (e.g., similar in style as moveable filing or utility/tool cabinets), ball bearings, and/or the like. In at least some other examples, the friction reducing element(s) may comprise at least one of a bearing and/or a chain that may be coupled to one or more gears. Any other configuration and/or feature may be implemented as the one or more friction reducing elements to facilitate movement of the plurality of solar panel arrays (e.g., 211). The one or more friction reducing elements may be used to facilitate movement in any direction, such as in a direction parallel to the rails 220 as shown in FIG. 2 and/or in a direction perpendicular to the rails 220 (e.g., using one or more rails (not shown) configured to be perpendicular to the rails 220).

The frame 250 may comprise any shape. For example, while the moveable frame 250 is shown in FIG. 2 as generally comprising four legs/posts, two inter-row joiners 900 (e.g., one on either side), and linear mounting portions connecting the legs/posts on opposite sides and connecting the solar panels to the moveable frame 250 (e.g., two solar panel arrays connected to a single frame structure), the frame 250 may comprise additional or alternative portions, such as sides with cross-sections resembling an upside-down V-frame, an upside-down U-frame, or an A-frame, and/or truss-like structures along the width of the frame 250 and/or at the sides of the frame 250 which may provide support for the weight of the solar panels. Reference herein to “leg(s)/post(s),” “leg,” and/or “leg 251” may refer to one or more of a leg, a post, and/or any other structure configured to support the frame 250 on a surface, such as the ground and/or a ground-mounted structure. While an example of a leg is shown as leg 251 in FIG. 2C, the moveable solar panel system described herein may be used with any other structure corresponding to a leg.

The wheel assemblies 600 may be configured to be attached to two legs on both sides of the moveable frame 250. Additionally or alternatively, the moveable frame 250 may be configured to accommodate solar panels on two sides, and/or to enable one or more solar panels to be moved (e.g., flipped/turned) from one side to another side, which may enable increased solar power production for a longer duration of a day (e.g., as the sun is setting, solar panels having their surface facing away from the sun may be flipped/turned to re-face the sun, to generally track the sun). The moveable frame 250 may be customized and/or adjusted to any height, for example, to accommodate certain access to land covered by the solar panel array system 200 (e.g., grazing, irrigation, harvesting, seeding, etc.) during a time that the system 200 is configured for solar power generation over that land, and/or to accommodate different crops for different heights throughout a growing season. For example, the moveable frame 250 may comprise one or more vertical adjustment elements that may comprise at least one of: a spring-loaded notch coupled with a plurality of vertically spaced holes, a turn-dial coupled with gear, and/or a motor coupled with an electronic controller. The moveable frame 250 may comprise one or more add-on features that may assist with certain agricultural uses, such as hooks, pipes, and/or hoses. At least some moveable frames 250 (e.g., located at outer rows of the system 200) may comprise additional elements such as hitches and/or attachments for agricultural tools and/or equipment (e.g., seed spreaders, aerators, etc.). The moveable frame 250 may be configured with one or more gutters and/or other rainwater collection devices which may direct rainwater (e.g., collected from sliding across solar panels) to cisterns, rain barrels, and the like.

One or more solar panel arrays 211 may comprise one or more attachments configured to facilitate movement of the respective solar panel array(s) (e.g., either separately or in combination with movement of a plurality of solar panel arrays). For example, one or more inter-row joiners may couple a plurality of solar panel arrays. While an example of an inter-row joiner is shown as the inter-row joiner 900 in FIG. 2B, the inter-row joiner may comprise any size and/or shape. The one or more attachments may comprise, for example, at least one of a tractor pull/hitch, a cable, or a motor. For example, solar panel arrays 211 that may be relatively shorter (and, as a result, lighter) may be moved manually and/or via a crank (e.g., powered manually as a manual crank and/or an electrical crank powered via one or more electrical and/or hydraulic source(s), and/or the like) and/or pulley system. Solar panel arrays 211 that may be relatively longer (and, as a result, heavier) may be moved using an electrical motor and/or pushed/pulled by a tractor and/or other vehicle. In at least some examples, such as for significantly heavy solar panel arrays 211, a cable may be used/installed, such as next to at least one of the connecting mechanisms 231 and/or 232 and/or along one or more rails 220, whereby each solar panel array 211 may be (e.g., temporarily) connected to the cable that may further be coupled to an engine that may pull the cable, along with any connected solar panel array(s) 211, to the desired location.

FIG. 2A shows a portion 200A of the moveable solar panel system of FIG. 2. A rail 220 may comprise groves, for example, for one or more wheels to sit within and/or to roll upon. While FIG. 2A shows a rail 220 without a brace or physical connector sides, such structures may be included with the rail 220, for example, to improve durability and structure integrity and/or to prevent lateral movement of the frame 250 off of the rail 220. As shown in FIG. 2A, the rail 220 may be mounted to one or more footings. For example, the rail 220 may be mounted on one or more supports 261 and/or on one or more pedestals 262. The supports 261 may be moveable to support the rail 220 being installed and/or relocated in a relatively quick and easy manner. The support 261 may operate as a spacer. The support 261 may comprise a curved upper surface (as shown) or a substantially flat upper surface, and/or the support 261 may comprise a surface that is complementary to the lower surface of the rail 220 to facilitate coupling the support 261 with the rail 220 along a level surface. The support 261 may comprise a substantially flat or angular lower surface to facilitate placement on the ground or other surface in a manner that provides a level top surface for the rail 220. Different supports 261 may be used for different surface conditions (e.g., flat, angled, rough, smooth, etc.). For example, along surfaces that are relatively smooth and/or slippery, the support 261 may comprise one or more friction elements on its lower surface. As another example, for surfaces that are sloped (e.g., in a consistent or changing slope along a length), the support 261 may comprise one or more slopes on its lower surface and/or the support 261 may be adjustable to one or more slopes (e.g., compressible material such as foam, mechanical adjustment element(s) to adjust slope, etc.). An underside and/or side of the rail 220 may comprise physical connector teeth and/or other elements for engagement with the support 261 to facilitate maintaining a positioning. Additionally or alternatively, the rail 220 may comprise one or more ridge, cutouts, grooves, indents, and/or protrusions on or near the sides and/or edges to facilitate connection with the support 261.

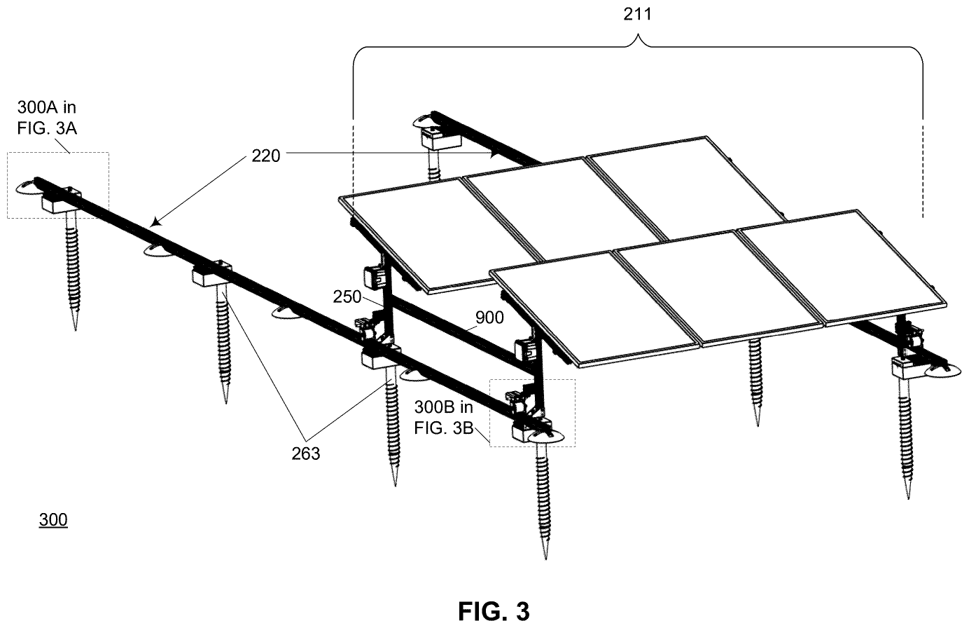

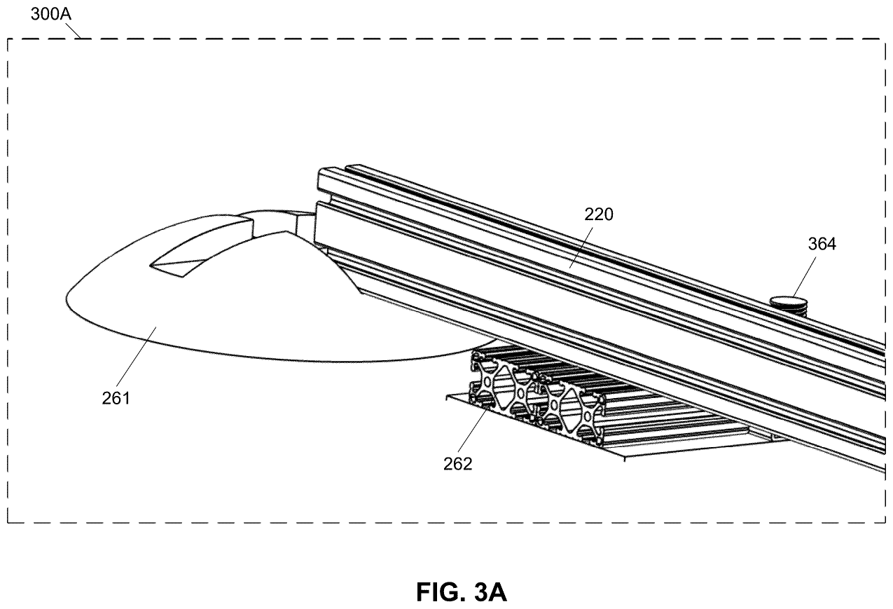

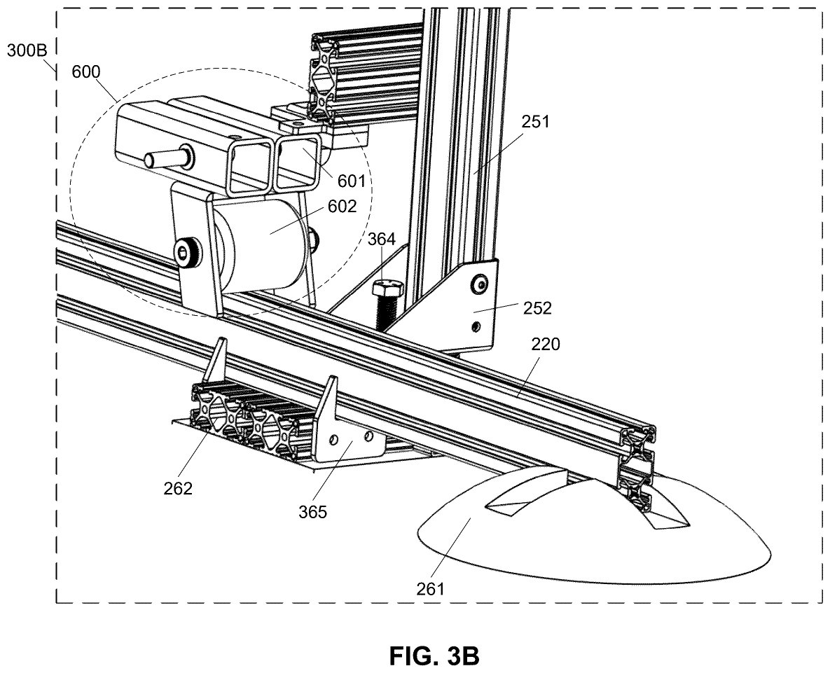

The pedestals 262 may comprise one or more removable portions and/or one or more fixed portions. For example, at least one portion of the pedestal 262 may be coupled to and/or may comprise a ground-mounted component (e.g., that may protrude underground) to provide improved stability for the rail 220 and which may provide improved movement of the solar panel arrays 211 along the rail 220. The pedestal 262 may comprise an outer covering (not shown) and/or the pedestal 262 may comprise any shape and/or size. A pedestal 262 may correspond to a location at which a leg of the moveable frame 250 may be secured, such that the solar panel arrays 211 are in a fixed position during a solar power configuration. For example, the system 200 shown in FIG. 2 with four pedestals 262 underneath each rail 220 may accommodate three different positions of the moveable frame 250 (e.g., a first position with legs at lines L3 and L4 as shown in FIG. 2, a second position with legs at lines L2 and L3, and a third position with legs at lines L1 and L2), whereby each of the four legs of the moveable frame 250 may each be secured to a pedestal 262 during a solar power configuration. While FIG. 2 generally shows five supports 261 along each rail 220, and four pedestals 262 along each rail 220, any number of supports 261 and/or pedestals 262 may be used to support any number of rails 220. Accordingly, the system 200 shown in FIG. 2 may be expanded to cover a larger area, or reduced to cover a smaller area, and such changes may correspond to an increase or decrease in a number of supports 261 and/or pedestals 262 being used. The pedestal 262 may be configured in a variety of different sizes and/or shapes in order to accommodate a variety of difference sizes and/or shapes of the leg 251 of the moveable frame 250. The pedestal 262 may be secured to a surface (e.g., ground, grass, pavement, and/or any other surface) using one or more screws 263 (shown in-part in FIG. 2B), bolts, and/or the like. The pedestal 262 may comprise groves, for example, for wheels to sit within and/or to roll on. The pedestal 262 and/or the rail 220 may comprise one or more side pieces, such as a mounting bracket 365 shown in FIG. 3B. Such side piece(s) may be configured to restrict, limit, and/or prevent movement of the frame 250 in a lateral direction (e.g., left and/or right to the direction of movement along the rail 220), for example, by at least partially enclosing the pedestal 262 and/or the rail 220. Additionally or alternatively, side pieces may be configured to restrict, limit, and/or prevent movement of the frame 250 in an upward direction (e.g., away from the surface/ground), such as due to high wind and/or other upward force.

The pedestals 262 may be installed in the ground using one or more securing mechanisms. For example, the pedestals 262 may be bolted in a manner similar to railroad ties. Additionally or alternatively, pedestals 262 may be hammered into the soil. Additionally or alternatively, pedestals 262 may be secured via concrete, rebar, screws (e.g., screw 263 shown and described with respect to FIG. 3), bolts/nuts, ground posts, weighted ballasts, and/or any combination thereof. Row length of the solar panel arrays 211 may be configurable on site, for example, to cover any area that is desired for solar power generation and some other land use. While pedestals 262 may be installed for long-term and/or permanent placement, the use of rails 220 to enable movement of the solar panel arrays 211 may enable movement of the solar panel arrays 211 without damage and/or with minimal or no negative impact to land. Additionally or alternatively, the use of rails 220 to enable movement of the solar panel arrays 211 may enable additional use of the land underneath the rails 220 if the rails 220 are removed from the land (e.g., after the solar panel array(s) 211 is/are moved to a desired location such as for solar power generation). In contrast to the solar power system 200, a solar power system that may be mobilized with wheels but without the benefit of rails 220 as described herein may damage land (e.g., destroy crops, damage grass, leave tracks, etc.) due to the relatively heavy nature of solar panel arrays and related equipment. However, by using rails 220 as described herein, land between the rails 220 and land outside of the rails 220 (e.g., to the left of the left-most rail and/or to the right of the right-most rail 220) may be undisturbed by the movement of solar panel arrays 211. As a result, systems and methods described herein may provide advantages of a flexible solar power generation system having minimal or no negative impact on land caused by movement of solar panel arrays, and/or by providing a flexible system in which rails 220 may be removed when not in used to allow further access to land such as for agricultural purposes.

FIG. 2B shows a portion 200B of the moveable solar panel system of FIG. 2. One or more connecting mechanisms 231 and/or 232 may be attached to the moveable frame 250, such as to a leg as shown in FIG. 2B. In at least some examples, the one or more connecting mechanisms 231 and/or 232 may be provided on only one side of the moveable frame 250. In at least some other examples, the one or more connecting mechanisms 231 and/or 232 may be provided on both sides of the moveable frame 250. Each leg may be coupled on one side by an inter-row joiner 900. While only two legs are shown on each side of the moveable frame 250, any number of legs may be included, each of which may be coupled to the moveable frame by at least one inter-row joiner 900. In at least some examples, the inter-row joiner 900 may be in a fixed position relative to the frame 250 and may not be rotatable. In at least some other examples, the inter-row joiner 900 may be (optionally) rotatably attached to at least one of the legs of the moveable frame 250 (e.g., the left-shown leg coupled to the connecting mechanism 231), which may facilitate movement of another leg (e.g., the right-shown leg coupled to the connecting mechanism 232) in an upwards or downwards direction relative to the rotatably attached leg. Such rotatable attachment may be made via a pin, roller, shaft, and/or the like.

Each leg of the moveable frame 250 may be coupled to a respective wheel assembly 600. An example wheel assembly 600 is shown in more detail in FIG. 6A and in FIG. 6B. When the moveable frame 250 is in a moveable position, the wheel assembly 600 may be in a configuration such as shown in FIG. 2B, with a shaft of the wheel assembly 600 (e.g., a portion above a wheel) in a position that is substantially horizontal to the inter-row joiner 900, and with the wheel of the wheel assembly touching the rail 220. FIG. 2B also shows two pedestals 262, each of which comprise a portion located above ground (e.g., such as shown in FIG. 2A) and a portion located below ground (e.g., below the surface upon which the support 261 is mounted). The portion of the pedestal 262 that is located below ground may comprise a fixed material (e.g., a permanent installation), such as cement, concrete, and/or the like. The pedestal 262 may be coupled to a ground securing element, such as a screw 263, bolt, pin, and/or the like.

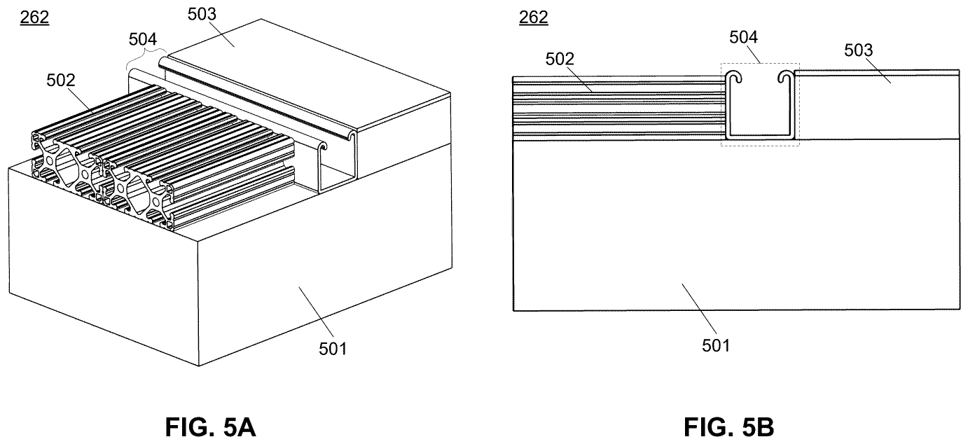

FIG. 2C shows a portion 200C of the moveable solar panel system of FIG. 2. When the moveable frame 250 is in a moveable position or is almost ready to be moved, the wheel assembly 600 may be in a configuration such as shown in FIG. 2C, with a shaft 601 of the wheel assembly 600 (e.g., a portion above a wheel 602) in a position that is substantially horizontal to rail 220 and/or to the inter-row joiner 900, and with the wheel 602 of the wheel assembly 600 touching or about to be resting upon the rail 220. In such a moveable position, a leg 251 of the moveable frame 250 is in a position raised above the ground such that weight of the moveable frame 250 rests upon the wheel 602 (pushing downward on top of the rail 220) and not upon the bottom of the leg 251. In such a moveable position, the leg 251 may be raised by a height of approximately height 270 shown in FIG. 2C or by a height greater than or less than height 270. By raising the leg 251, friction between the bottom of the leg 251 and a ground surface may be reduced and/or eliminated, to facilitate easier movement of the moveable frame 250 along the rail 220 using the wheel 602. While only one leg 251 is shown in FIG. 2C, each moveable frame 250 may comprise at least four legs, each coupled to one of at least four respective wheel assemblies 600, such that no leg of the moveable frame 250 is touching a ground surface during movement of the moveable frame 250. When the moveable frame 250 is at a desired location (e.g., if a respective solar panel array 211 is ready to be connected for solar power generation), the moveable frame 250 may be directed downwards such that each leg 251 may be lowered (e.g., by height 270) onto a respective pedestal 262. The leg 251 may then be coupled to a mounting bracket 252, for example, which may facilitate attaching the leg 251 to the pedestal 262, such as by one or more bolts, as described further herein. The mounting bracket 252 may be inserted onto and/or around the leg 251, for example, to secure the leg 251 to one or more portions of the pedestal 262. The mounting bracket 252 may abut, float above, and/or attach to one or more other brackets. The mounting bracket 252 may be secured to a leg-mount portion 503 of the pedestal 262 (as shown and described with respect to FIG. 5A and FIG. 5B), for example, with one or more bolts, screws, and/or the like (e.g., bolt 364 as shown and described with respect to FIG. 3A and FIG. 3B). The mounting bracket 252 may be attached and/or coupled to one or more ballasts. In at least some examples, cabling may be used to assist in securing the pedestal 262 to the ground and/or to one or more ballasts. The ballast(s) may provide a mass that, by gravitational force, may help to secure a solar panel array comprising the moveable frame 250 from lifting upward, such as due to high winds and/or other forces. In at least some examples a base portion 501 (shown in FIG. 5A and FIG. 5B) of the pedestal 262 may operate as a ballast. The ballast(s) may be configured to be a sufficient weight so as to counteract upward force that may be generated from high winds (e.g., at least up to, if not exceeding, eighty-five miles per hour). The ballasts may be made of cement, metal, and/or any other durable and relatively heavy material. The ballasts may be moveable or may be sufficiently weighted so as to prevent their movement.

FIG. 3 shows an example of a moveable solar panel system. A moveable solar panel system 300 may comprise one or more solar panels and one or more rails/tracks. The one or more solar panels may correspond to one or more arrays of solar panels. The system 300 of FIG. 3 may correspond to the same system 200 of FIG. 2, shown in FIG. 3 from a different direction. Any of the features with respect to the solar panel system 100 described and/or shown with respect to FIG. 1, and/or any of the features with respect to the solar panel system 200 described or shown with respect to FIG. 2, may correspond to elements of FIG. 3. For example, solar panel arrays of the system 300 may correspond to solar panel arrays 211 described with respect to FIG. 2. As another example, the moveable frame of the system 300 may correspond to the moveable frame 250 described with respect to FIG. 2. The system 300 may comprise ground securing elements such as screws 263, shown in-part in FIG. 2B and more fully in FIG. 3. The rails in FIG. 3 may correspond to the rails 220 described with respect to FIG. 2. FIG. 3A and FIG. 3B each shows a portion of the moveable solar panel system of FIG. 3 corresponding to areas 300A and 300B, respectively, in FIG. 3.

FIG. 3A shows a portion 300A of the moveable solar panel system of FIG. 3. As shown, a rail 220 may be mounted to one or more footings. For example, the rail 220 may be mounted on one or more supports 261 and/or on one or more pedestals 262. At least one portion of the pedestal 262 may be coupled to and/or may comprise one or more ground securing elements such as screws 263 (e.g., that may protrude underground) such as shown in FIG. 3. The ground securing elements may provide improved stability for the rail 220 which may provide improved movement of the solar panel arrays 211 along the rail 220. The pedestal 262 may be secured to a leg of the moveable frame 250 via one or more physical connectors, such as a bolt 364.

FIG. 3B shows a portion 300B of the moveable solar panel system of FIG. 3. As shown, the rail 220 may be mounted to one or more footings, such as a support 261 and/or a pedestal 262. The pedestal 262 may comprise and/or may be coupled with a mounting bracket 365 that may help to maintain positioning of the rail 220, such as by preventing lateral movement towards and/or away from one or more legs 251 of the moveable frame 250. Any of the features with respect to the solar panel system 200 described and/or shown with respect to FIG. 2, including any feature shown and/or described with respect to FIG. 2C, may correspond to elements shown in FIG. 3B.

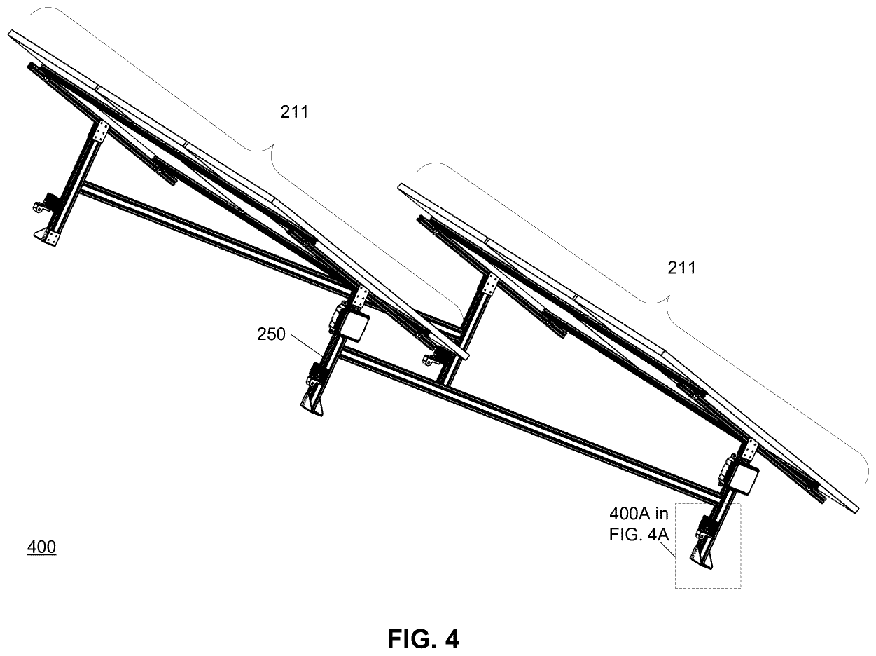

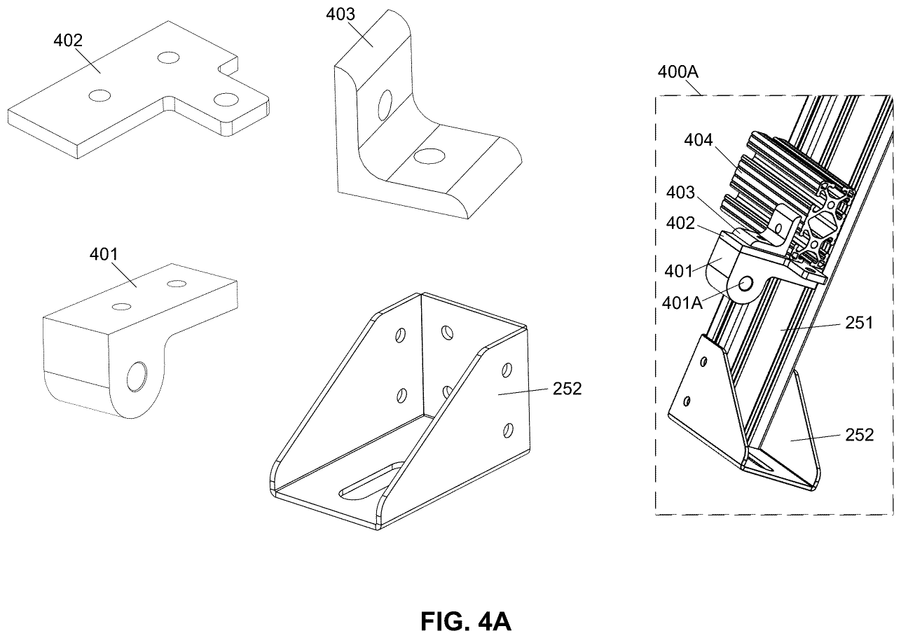

FIG. 4 shows an example of a connected array carriage for a solar panel system. A fixed or moveable solar panel system 400 may comprise one or more solar panels. The one or more solar panels may correspond to one or more arrays of solar panels. The system 400 of FIG. 4 may correspond to the same system 200 of FIG. 2, shown in FIG. 4 from a different angle and without rails 220 or footings (e.g., supports 261 and/or pedestals 262). Any of the features with respect to the solar panel system 100 described and/or shown with respect to FIG. 1, any of the features with respect to the solar panel system 200 described and/or shown with respect to FIG. 2, and/or any of the features with respect to the solar panel system 300 described and/or shown with respect to FIG. 3 may correspond to elements of FIG. 4. Four legs of the frame 250 in FIG. 4 may be mounted to a ground surface, such as at the pedestals 262 described with respect to FIG. 2 and/or FIG. 3. A portion 400A of the system 400 is shown in more detail in FIG. 4A.

FIG. 4A shows example components and a portion 400A of the connected array carriage of FIG. 4. Each leg of the connected array carriage in system 400 may be configured for mounting to a ground surface using a bracket 252. The leg may be configured with one or more attachment portions 404 for coupling with a wheel assembly, such as the wheel assembly 600 shown in FIG. 6A and FIG. 6B. In at least some examples, the one or more attachment portions 404 may be coupled to a mounting bracket 402 and/or may be secured to the leg via a securing bracket 403. At least one of the mounting bracket 402 and/or the securing bracket 403 may be attached to a wheel assembly bracket 401. Any of the brackets described with respect to FIG. 4A (e.g., bracket 252, wheel assembly bracket 401, mounting bracket 402, securing bracket 403) may be referred to herein as a leg bracket (or collectively as leg brackets). The wheel assembly bracket 401 may comprise a cavity 401A for receiving the wheel assembly 600. Each leg of the frame 250 may comprise one or more of the components shown in FIG. 4A, including one or more of the components in portion 400A.

The mounting bracket 252 may comprise one or more holes, other cutouts, and/or structures that may be configured for alignment with one or more holes, other cutouts, and/or structures of the pedestal 262 (such as an attachment portion 504 shown and described with respect to FIG. 5A and FIG. 5B), such as for insertion of one or more screws, bolts, and the like. Additionally or alternatively, the mounting bracket 252 may be comprise one or more holes, other cutouts, and/or structures that may be configured for attaching the mounting bracket to the frame 250 (e.g., at leg 251), such as via a screw, bolt, and/or the like. The mounting bracket 252 may be configured for purposes of securing the frame 250 to the pedestal 262 and/or to a surface such as the ground.

FIG. 5A shows an angled profile view of an example mounting structure for a frame and/or a rail of a moveable solar panel system. FIG. 5B shows a side view of the example mounting structure of FIG. 5A. The mounting structure may correspond to the pedestal 262 of FIG. 2, shown in more detail in FIG. 5A and FIG. 5B. For example, the pedestal 262 may comprise a base portion 501, a rail-mount portion 502, a leg-mount portion 503, and an attachment portion 504. The base portion 501 may be made of material configured to support a relatively heavy weight so as to provide a stable position for a leg of a frame (e.g., frame 250) to be mounted. The rail-mount portion 502 may be configured to provide a surface for mounting the rail 220. The rail-mount portion 502 may be adjustable and/or adaptable to accommodate variations in height suitable for relatively level placement of the rail 220. The leg-mount portion 503 may comprise a substantially flat top surface to accommodate mounting of a leg of the frame 250 such as via the mounting bracket 252. The attachment portion 504 may comprise a cavity for placement of one or more of a nut, a spring, a spacer, a washer, and/or a portion of a bolt. As an example, a bolt (e.g., 364) may be mounted through the top of the mounting bracket 252 and into the cavity of the attachment portion 504. Underneath the inward curved top edges of the attachment portion 504, a nut (not shown) may be provided for attachment to the bolt to secure the leg of the frame to the leg-mount portion 503 of the pedestal 262. One or more of a spring, a spacer, and/or a washer may be included within the cavity of the attachment portion 504, which may be used to improve alignment and/or case of connection of the nut onto the bolt and/or to retain nut placement within the cavity upon removal of the bolt.

In at least some examples, the base portion 501 may be mounted at or below ground level. For example, if the base portion 501 is below ground level, a top surface of the leg-mount portion 503 may be approximately at ground level. In such a configuration in which at least a portion of the pedestal 262 (e.g., at least a portion of the base portion 501) is below ground level, the land around the pedestal 262 may be made more easily accessible and/or available for agricultural use by not having components of the pedestal 262 obstructing equipment and/or other access to the surrounding land. Additionally or alternatively, wheels, rollers, and/or springs (not shown) may be placed along one or more sides of the pedestal 262 such as at the rail-mount portion 502, for example, so as to reduce friction and/or enable movement of the frame 250 along the rail 220. The base portion 501 may rest on the ground or other surface and may be secured by one or more screws 263, bolts, and/or the like. The pedestal 262 may be made of metal, composite material, and/or any other material of sufficient strength and durability to withstand the weight and movement of solar panel arrays.

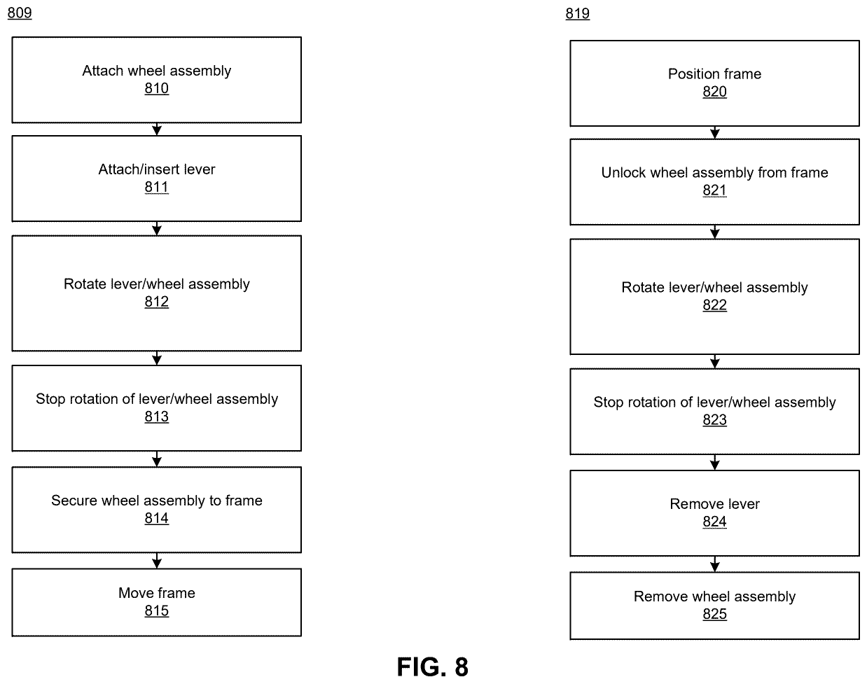

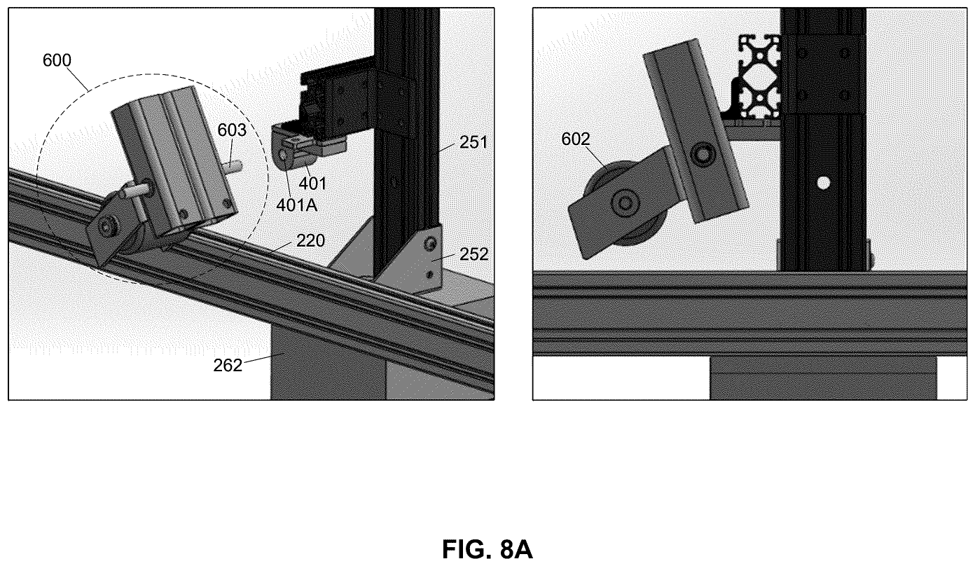

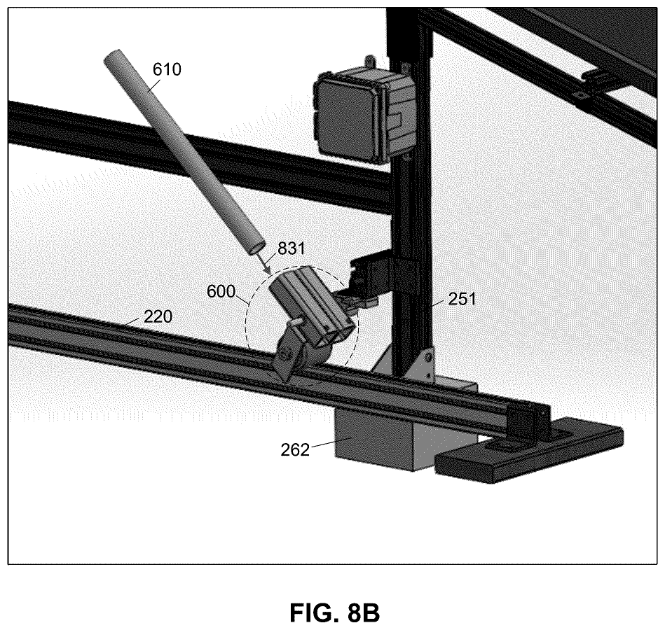

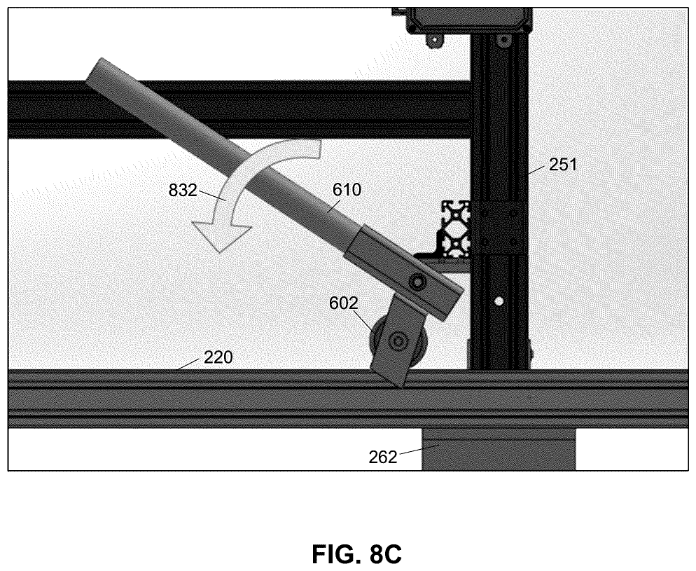

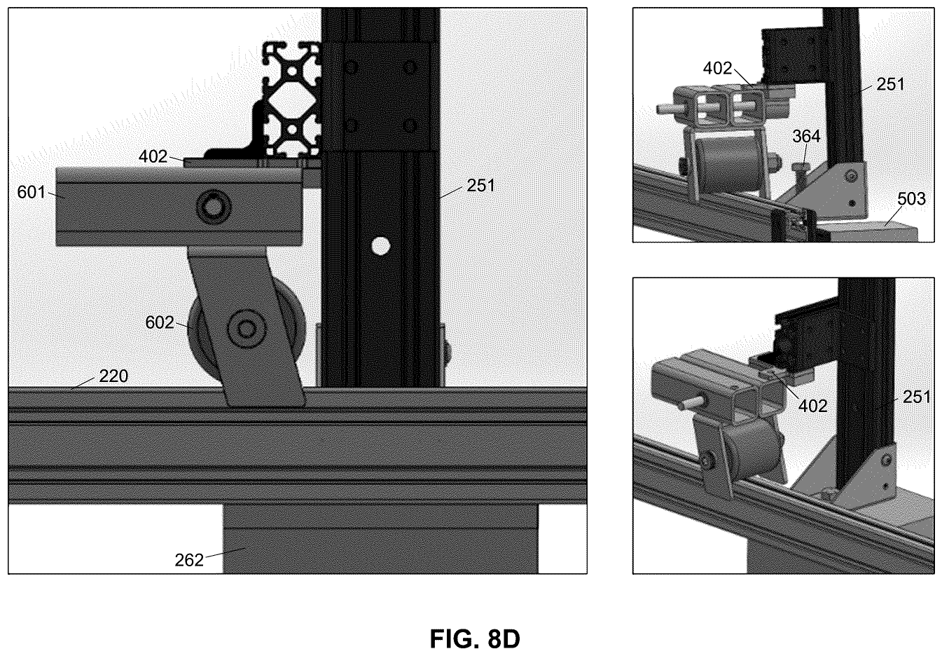

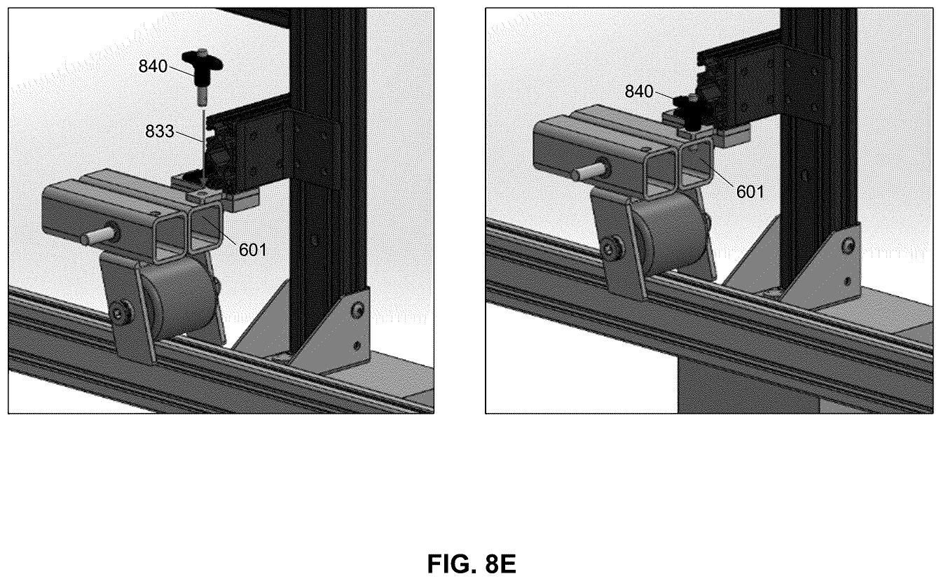

FIG. 6A and FIG. 6B show different views of an example wheel assembly for a moveable solar panel system. The wheel assembly 600 may comprise at least one wheel 602 that may be rotatable along an axis. The wheel 602 may be mounted to a wheel bracket 604 via a bolt 605, pin, roller, and/or any other mechanism allowing rotation of the wheel 602 relative to the wheel bracket 604. The wheel bracket 604 may comprise side portions that may extend along at least a portion of the rail 220, which may help to maintain alignment of the wheel 602 along a top surface of the rail 220. The wheel assembly 600 may comprise one or more shafts 601 that may be coupled to the wheel bracket 604. In at least some examples, the wheel bracket 604 may be rotatable relative to the one or more shafts 601 (e.g., such as by use of a pin, roller, or any other mechanism to rotatably attach the wheel bracket 604 to the one or more shafts 601). By being rotatable in this manner, the wheel assembly 600 may be configured to allow rotation in a plurality of directions (e.g., parallel to the rails 220 shown in FIG. 2 and/or perpendicular to the rails 220 shown in FIG. 2, such as along one or more additional lateral rails (not shown) that may be perpendicular to the rails 220). Such a rotatable wheel bracket 604 may be configured to be rotatable at one or more pre-determined angles, such as by one or more groves, slots, pins, and and/or other structure(s) that facilitate rotation in a fixed angle (e.g., plus or minus 90-degrees, or plus or minus 270-degrees). The one or more shafts 601 may be configured to receive a pin 603 that may be used to facilitate positioning of the wheel assembly 600 relative to a wheel assembly bracket (e.g., bracket 401 in FIG. 4A) via a corresponding cavity (e.g., 401A) in the wheel assembly bracket. The pin 603 may be configured to enable rotation of the wheel assembly 600 about a fixed point (e.g., 401A) on or near a leg (e.g., 251) of the frame 250. The one or more shafts may comprise a cavity and/or attachment portion for coupling with a lever (such as shown and described with respect to the lever 610 in FIG. 8B).

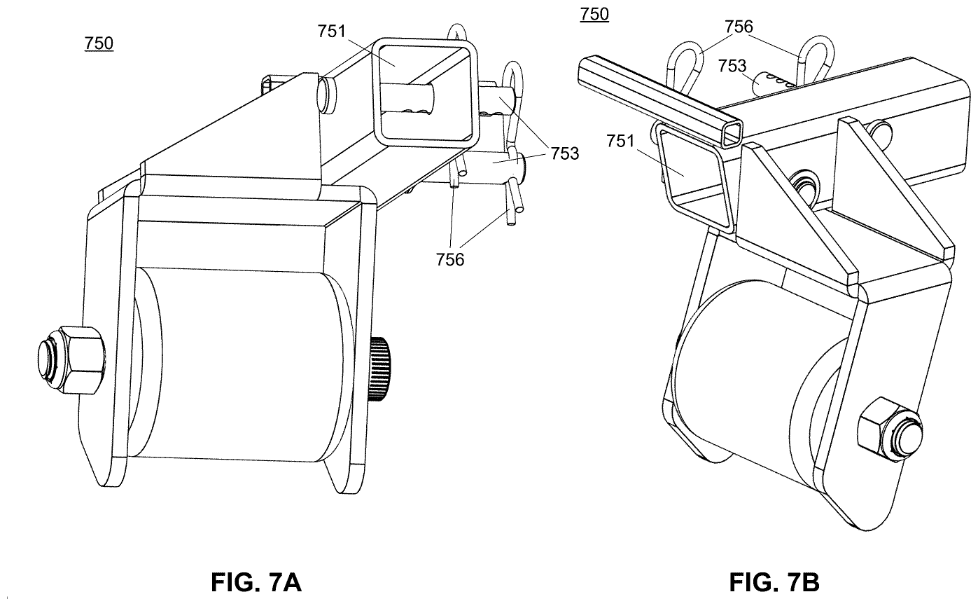

FIG. 7A and FIG. 7B show different views of an alternative example wheel assembly for a moveable solar panel system. A wheel assembly as described herein may comprise a wheel assembly 750 as shown in FIG. 7A and FIG. 7B. The wheel assembly may comprise a shaft 751, one or more pins 753, and/or one or more retaining rings 756. In at least some examples, one or more wheel assemblies 750 may be used with a respective one or more legs of a frame (e.g., frame 250) on a first side and one or more mirror-image configured variations of the wheel assembly 750 may be used with respective one or more legs of the frame on a second side (e.g., opposite from the first side). One or more operations described with respect to the wheel assembly 750 may correspond to operations described with respect to the wheel assembly 600.

FIG. 8 shows example methods relating to moving a solar panel system. FIGS. 8A-8E show additional details corresponding to steps of example methods of FIG. 8. The solar panel system referenced with respect to FIG. 8, FIGS. 8A-8E, and associated descriptions may comprise any solar panel system, such as system 100, system 200, system 300, system 400, and/or any solar panel system described herein (e.g., system 700 described with respect to FIG. 9A and FIG. 9B).

A method 809 may comprise a method for configuring a solar panel system for movement to a location. At step 810, a wheel assembly may be attached to the solar panel system. The wheel assembly may comprise wheel assembly 600 or any other wheel assembly referenced herein. FIG. 8A shows example details corresponding to step 810. For example, as shown in FIG. 8A, the wheel assembly 600 may comprise a pin 603 that may be inserted into a cavity of a portion of the solar panel system. For example, the cavity may be the cavity 401A located in the wheel assembly bracket 401 that may be coupled to a leg 251 of a frame (e.g., frame 250) of the solar panel system. After coupling the wheel assembly 600 to the solar panel system, the wheel assembly 600 may be (optionally) secured to the solar panel system, such as by one or more clips, pins, and/or locks (not shown). For example, one or more retaining rings (such as retaining rings 756 shown in FIG. 7A and FIG. 7B) may be inserted into one or more holes of the pin 603 (such as holes shown in pins 753 of FIG. 7A and FIG. 7B) that may secure the wheel assembly 600 to the leg 251 (e.g., at the wheel assembly bracket 401).

In at least some examples, during step 810, the leg 251 may be secured to the pedestal 262 (e.g., via mounting bracket 252 and at least one bolt such as bolt 364). In at least some other examples, during step 810, the leg 251 may not be secured to the pedestal 262. During step 810, the wheel 602 of the wheel assembly 600 may be configured so as to not touch the rail 220 and/or to rest on the rail 220 without exerting force on the rail 220 beyond the weight of the wheel assembly 600 itself (e.g., without transferring a force corresponding to a weight of the solar panel system comprising the leg 251).

Step 810 may be performed for each of a plurality of legs (e.g., four legs 251) of a solar panel system. Each leg of the solar panel system may be coupled to a same (e.g., at different times) or similar wheel assembly 600. For example, on a leg opposite to the leg 251 shown in FIG. 8A, a corresponding wheel assembly 600 for that opposite leg may comprise one or more components that are mirror-image reversed relative to the respective component shown in FIG. 8A. As another example, the wheel assembly 600 may be configured for use on any leg of the solar panel system, such as by having the pin 603 configured to extend outwards from the wheel assembly 600 in two, opposite directions (e.g., for coupling to a leg on either of opposite sides of the solar panel system), such as shown in FIG. 8A. In at least some systems, step 810 may be skipped/optional, for example, if a wheel assembly 600 is already coupled to the solar panel system (e.g., from a prior performance of step 810 or as an integral component of the solar panel system). In at least some other systems, step 810 may be performed prior to each occurrence of moving the solar panel system.

At step 811, a lever may be (optionally) attached to the wheel assembly 600. FIG. 8B shows example details corresponding to step 811, in which a lever 610 may be inserted into a shaft of the wheel assembly 600, in a direction as shown by arrow 831. In at least some examples, the wheel assembly 600 may comprise an integrated lever and/or may already be coupled to a lever such that this step may be skipped. The lever 610 may be secured to the wheel assembly 600 via one or more clips, pins, and/or locks. In at least some examples, the lever 610 may be free to rotate and/or move into or out from the wheel assembly 600. In at least some examples, the lever 610 may be screwed into a shaft of the wheel assembly. Step 811 may be performed for each of a plurality of wheel assemblies 600, wherein each wheel assembly 600 may be coupled to a respective leg of a plurality of legs (e.g., four legs 251) of a solar panel system. In at least some examples, rotation of the wheel assembly 600 may be automated (e.g., such as by a motor, actuator, etc.) such that step 811 may be skipped.

Before step 812 (e.g., prior to and/or after one or more of steps 810 and 811), for each leg of the solar panel assembly, one or more elements that may secure the leg 251 to the pedestal 262 may be detached. For example, the bolt 364 (shown in FIG. 3B) may be unscrewed from the mounting bracket and/or from the pedestal 262. The leg 251 may be made free to move upward off from the pedestal 262 and/or off from a ground surface, for example, prior to step 812.

At step 812, the lever 610 and/or the wheel assembly 600 may be rotated. In at least some examples, the wheel assembly 600 may be rotated in an automated manner, such as by a motor, an actuator, one or more sensors, and/or one or more controllers (e.g., a remote controller, a software program, and/or the like). In at least some other examples, the wheel assembly 600 may be rotated by manual force, such as by pushing in a generally downward direction (e.g., toward a ground surface). FIG. 8C shows example details corresponding to step 812. As shown in FIG. 8C, the lever 610 and/or the wheel assembly 600 may be rotated in a first direction (e.g., counter-clockwise direction) as shown by curved arrow 832. In at least some other examples, the lever 610 and/or the wheel assembly 600 may be rotated in a second direction (e.g., clockwise direction) opposite from curved arrow 832, for example, if step 812 is performed for a different leg of the solar panel system (e.g., opposite side on a different rail) and/or if the wheel assembly 600 is attached on an opposite side (e.g., using an opposite portion of the pin 603 to couple with the cavity 401A). A wheel 602 of the wheel assembly 600 may be configured to rest on a top surface of the rail 220 during at least a portion of step 812. For example, at the beginning of step 812 the wheel 602 may not touch a top surface of the rail 220, and at a later time during step 812 the wheel 602 may be directed to touch the top surface of the rail 220. During step 812, at least a portion of a weight of a frame (e.g., frame 250) may be transferred to the wheel 602 as a force upon the wheel 602 and against a top surface of the rail 220 during at least a portion of step 812. During step 812, a leg 251 of the frame may be raised by a height, such as height 270 shown in FIG. 2C, whereby the leg 251 of the frame may no longer rest upon a surface (e.g., leg-mount portion 503 of the pedestal 262). In at least some examples, step 812 may be performed in parallel for each of the plurality of legs of the solar panel system. In at least some other examples, step 812 may be repeated, separately for each leg (e.g., at different times) of the solar panel system. For example, if performed by manual operation, step 812 may be performed by one person (e.g., for one leg at a time) or by multiple people (e.g., for multiple legs at a time, such as overlapping and/or substantially at a same time).

At step 813, rotation of the lever and/or rotation of the wheel assembly may be stopped. In at least some examples, stopping the rotation may be in an automated manner, such as by a motor, an actuator, one or more sensors, and/or one or more controllers (e.g., a remote controller, a software program, and/or the like). In at least some other examples, the rotation may be stopped by manual force. In at least some other examples, the rotation may be stopped by at least one stopping component, such as the mounting bracket 402 shown in FIG. 4A, to facilitate stopping of the rotation. FIG. 8D shows example details corresponding to step 813. As shown in FIG. 8D, the rotation from step 812 may end at step 813 at a position where a portion of the wheel assembly 600 (e.g., shaft 601) abuts a portion of one or more stopping elements (e.g., mounting bracket 402). At step 813, the leg 251 is in a position such that it is raised above the leg-mount portion 503 of the pedestal 262. At step 813, the bolt 364 remains either loosened or detached from the pedestal 262, for example, to enable the raised position of the leg 251 above the leg-mount portion 503 of the pedestal. In at least some examples, step 813 may be performed in parallel for each of the plurality of legs of the solar panel system. In at least some other examples, step 813 may be repeated, separately for each leg (e.g., at different times) of the solar panel system. For example, if performed by manual operation, step 813 may be performed by one person (e.g., for one leg at a time) or by multiple people (e.g., for multiple legs at a time, such as overlapping and/or substantially at a same time).

At step 814, a wheel assembly may be secured to the solar panel system. FIG. 8E shows example details corresponding to step 814. As shown in FIG. 8E, a pin 840 may be inserted into a hole or cavity of the mounting bracket 402 and into a hole or cavity of the wheel assembly (e.g., through a portion of the shaft 601). The pin 840 may be inserted in the direction of arrow 833. The pin 840 may comprise a locking pin or any other type of mechanism for physically securing two components to each other. The pin 840 may be configured to prevent the wheel assembly 600 from being (inadvertently) detached from the solar panel assembly, such as during movement of the frame 250. Additionally or alternatively, the pin 840 may be configured to prevent rotational movement of the lever 610 and/or the wheel assembly 600 in a direction opposite from the direction 832, for example, to prevent the leg 251 from moving in a downward direction (e.g., toward the ground and/or toward the leg-mount portion 503 of the pedestal 262). Step 814 may be performed for each leg 251 of a solar panel system.

At step 815, a frame may be moved. For example, a frame 250 of the solar panel system 211 may be moved from its current position shown in FIG. 2 (e.g., at pedestals 262 along lines L3 and L4) to another position (e.g., at pedestals 262 along lines L2 and L3, or at pedestals along lines L1 and L2). One or more mechanisms may be attached to and/or integral with the solar panel system 211 (e.g., coupled to or as part of the frame 250) that may be used to further facilitate movement of the solar panel arrays, such as a handle, tractor pull, motor, gear(s), pulley(s), cable(s), and the like.

Method 819 comprises a method for configuring a solar panel system after movement to a location. At step 820, a frame may be positioned at a location, such as shown in FIG. 2 (e.g., at pedestals 262 along lines L3 and L4).

At step 821, a wheel assembly may be unlocked from a frame. In addition to showing an example of securing a wheel assembly to a solar panel system as described with respect to step 814, FIG. 8E also shows an example of unlocking a wheel assembly from a frame. As shown in FIG. 8E, a pin 840 may be removed from a hole of the mounting bracket 402 and from a hole of the wheel assembly 600 (e.g., through a portion of the shaft 601). The pin 840 may be removed in an upward direction, opposite from the direction of the arrow 833. Step 821 may be performed for each leg 251 of a solar panel system

At step 822, a lever and/or a wheel assembly may be rotated (e.g., in a reverse direction from the rotation in step 812). In addition to showing an example of an end to rotation of a lever and/or a wheel assembly as described with respect to step 812, FIG. 8D also shows an example at a beginning of a rotation of a lever and/or a wheel assembly (e.g., in a reverse direction from the rotation in step 812). In addition to showing an example of a rotation in the direction shown by arrow 832, FIG. 8C also shows an example of a rotation of the lever 610 and/or the wheel assembly 600 rotating in a direction opposite from the direction of arrow 832. In at least some examples, the wheel assembly 600 may be rotated in an automated manner, such as by a motor, an actuator, one or more sensors, and/or one or more controllers (e.g., a remote controller, a software program, and/or the like). In at least some other examples, the wheel assembly 600 may be rotated by manual force, such as by pulling in a generally upward direction (e.g., away from a ground surface), and/or at least in-part by gravitational force (e.g., from the weight of the solar panel system). As shown in FIG. 8C, the lever 610 and/or the wheel assembly 600 may be rotated in a second direction (e.g., clockwise direction) opposite from the direction of curved arrow 832. In at least some other examples, the lever 610 and/or the wheel assembly 600 may be rotated in a first direction (e.g., counter-clockwise direction) as indicated by curved arrow 832, for example, if step 822 is performed for a different leg of the solar panel system (e.g., opposite side on a different rail) and/or if the wheel assembly 600 is attached on an opposite side (e.g., using an opposite portion of the pin 603 to couple with the cavity 401A). A wheel 602 of the wheel assembly 600 may be configured to be removed from bearing a weight of the solar panel system to be resting on a top surface of the rail 220 during at least a portion of step 822. For example, at the beginning of step 822 at least a portion of a weight of a frame (e.g., frame 250) may be transferred to the wheel 602 as a force upon the wheel 602 and against a top surface of the rail 220, and at a later time during step 822 the wheel 602 may directed from a position touching a top surface of the rail 220 to no longer touching the top surface of the rail 220. During step 822, a leg 251 of the frame may be lowered by a height, such as height 270 shown in FIG. 2C, whereby the leg 251 of the frame may end up resting upon a surface (e.g., leg-mount portion 503 of the pedestal 262). In at least some examples, step 822 may be performed in parallel for each of the plurality of legs of the solar panel system. In at least some other examples, step 822 may be repeated, separately for each leg (e.g., at different times) of the solar panel system. For example, if performed by manual operation, step 822 may be performed by one person (e.g., for one leg at a time) or by multiple people (e.g., for multiple legs at a time, such as overlapping and/or substantially at a same time)

At step 823, rotation of a lever and/or a wheel assembly may be stopped. In at least some examples, stopping the rotation may be in an automated manner, such as by a motor, an actuator, one or more sensors, and/or one or more controllers (e.g., a remote controller, a software program, and/or the like). In at least some other examples, the rotation may be stopped by manual force and/or by gravitational force (e.g., upon the leg 251 and/or mounting bracket 252 resting on the leg-mount portion 503 of the pedestal 262). In at least some other examples, the rotation may be stopped by at least one stopping component. As shown in FIG. 8C, the rotation from step 822 may end at step 823 at a position where the wheel 602 is no longer touching the rail 602 or is resting on the rail 220 without exerting force from the weight of the solar panel assembly. At step 823, the leg 251 may be in a position such that it is generally resting upon the leg-mount portion 503 of the pedestal 262. In at least some examples, step 823 may be performed in parallel for each of the plurality of legs of the solar panel system. In at least some other examples, step 823 may be repeated, separately for each leg (e.g., at different times) of the solar panel system. For example, if performed by manual operation, step 823 may be performed by one person (e.g., for one leg at a time) or by multiple people (e.g., for multiple legs at a time, such as overlapping and/or substantially at a same time).

At step 824, a lever may be (optionally) removed from a wheel assembly. In addition to showing an example of attaching the lever 610 as described with respect to step 811, FIG. 8B also shows example details corresponding to step 824, in which the lever 610 may be removed from a shaft of the wheel assembly 600, in a direction opposite from the direction shown by arrow 831. In at least some examples, the wheel assembly 600 may comprise an integrated lever and/or may already be coupled to a lever such that this step may be skipped. Removing the lever 610 may comprise detaching one or more clips, pins, and/or locks that may be secured to the wheel assembly 600. In at least some examples, the lever 610 may be free to rotate and/or move into or out from the wheel assembly 600 such that removal may be performed without resistance. In at least some examples, the lever 610 may be screwed into a shaft of the wheel assembly such that removal may require unscrewing the lever 610. Step 824 may be performed for each of a plurality of wheel assemblies 600, wherein each wheel assembly 600 may be coupled to a respective leg of a plurality of legs (e.g., four legs 251) of a solar panel system. In at least some examples, rotation of the wheel assembly 600 may be automated (e.g., such as by a motor, actuator, etc.) such that step 824 may be skipped.

At step 825, a wheel assembly may be removed from a solar panel system. In addition to showing a wheel assembly being attached to the solar panel system as described with respect to step 810, FIG. 8A also shows example details corresponding to step 825, in which the wheel assembly 600 may be removed from the solar panel system. For example, as shown in FIG. 8A, the wheel assembly 600 may comprise pin 603 that may be removed from a cavity of a portion of the solar panel system. For example, the cavity may be the cavity 401A located in the wheel assembly bracket 401 that may be coupled to a leg 251 of a frame (e.g., frame 250) of the solar panel system. Before removing the wheel assembly 600 from the solar panel system, one or more clips, pins, and/or locks (not shown) may be removed, for example, if they were used to secure to wheel assembly 600 to the solar panel system. For example, one or more retaining rings (such as retaining rings 756 shown in FIG. 7A and FIG. 7B) may be removed from one or more holes of the pin 603 (such as holes shown in pins 753 of FIG. 7A and FIG. 7B) that may have secured the wheel assembly 600 to the leg 251 (e.g., at the wheel assembly bracket 401).

During, before, or after step 825, the leg 251 may be secured to the pedestal 262 (e.g., via mounting bracket 252 and at least one bolt such as bolt 364). In at least some examples, during step 825, the leg 251 may not be secured to the pedestal 262. During step 825, the wheel 602 of the wheel assembly 600 may be configured so as to not touch the rail 220 and/or to rest on the rail 220 without exerting force on the rail 220 beyond the weight of the wheel assembly 600 itself (e.g., without transferring a force corresponding to a weight of the solar panel system comprising the leg 251). Step 825 may be performed for each of a plurality of legs (e.g., four legs 251) of a solar panel system.

After step 825, if not yet performed, one or more elements may be used to secure each leg 251 to the pedestal 262. For example, the bolt 364 (shown in FIG. 3B) may be screwed into the mounting bracket and/or into the pedestal 262. The leg 251 may be made to move downward toward and rest upon the pedestal 262 and/or on a ground surface. The solar panel system may become stationary, for example, after its legs 252 are secured to respective pedestals 262.

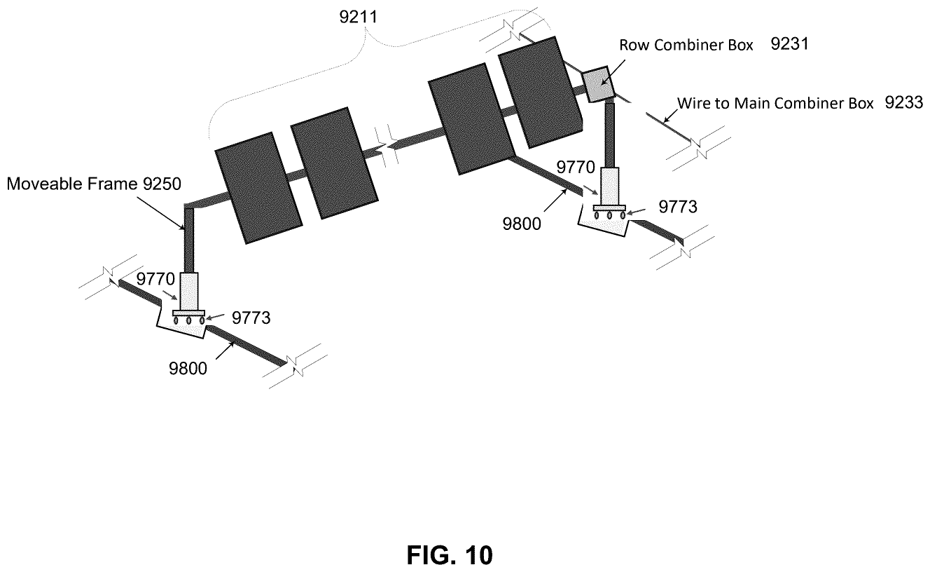

FIG. 9A shows an example of a mobile solar panel array system 700, comprising solar panel arrays 711 located in a first position, with connecting mechanisms 770 and connectors 800. The solar panel array system 700 may correspond to any solar panel array system described herein. In at least some examples, the connectors 800 may comprise the moveable connectors 9800 described herein such as with respect to FIGS. 10-14. Connecting mechanisms 770 may correspond to any footing described herein, such as the pedestal 262. Connectors 800 may correspond to any rail (or portion thereof) described herein, such as the rail 220. In at least some examples, connectors 800 may be moveable. In at least some other examples, connectors 800 may be secured in a fixed position (e.g., a permanently secured position that is not readily moveable).

FIG. 9B shows an example of the mobile solar panel array system 700 comprising solar panel arrays 711, located in a second position, with connecting mechanisms 770 and connectors 800. As used herein, a “position” of a solar panel array 711 and/or of a plurality of solar panel arrays 711 may refer to a “region” and/or an “area” in which the solar panel arrays 711 are located to generate electrical power (e.g., a solar power generation configuration). As shown in FIG. 9A and FIG. 9B, the first position and the second position may overlap within at least some region/area. Additionally, at least a portion of an area of a position (e.g., the first position) may be fully or substantially fully available for unfettered access to the land, such as for access to machinery of any height (e.g., tractors, combines, etc.), livestock of any height (e.g., longhorn cattle, sheep, goats, etc.), and people (e.g., farm workers) when the solar panel arrays 711 are moved to another position (e.g., the second position). Area of any other position similarly may be fully or substantially fully available to receive sunlight and/or to provide unfettered access to land when the solar panel arrays 711 are moved to another position.

As shown in FIG. 9A, the mobile solar panel array system 700 may comprise a plurality of solar panel arrays 711 that may be arranged for solar power generation in a first position, and that may be moveable, between connecting mechanisms 770, by using connectors 800 that connect the solar panel arrays 711 to at least a second position (and/or up to an N^{th} position) for solar power generation. As described herein, being in a configuration sufficient for solar power generation corresponds to the solar panel arrays 711 being arranged so as to accommodate potentially being exposed to the sun (e.g., if the sun were to be present) in order to generate electrical power. Being in a solar power generation configuration is in contrast to being arranged in a position for storage, such as with at least some solar panels covering surface area of other solar panels in a manner that may reduce overall surface area of the solar panel arrays and/or that may reduce overall storage space (e.g., while potentially sacrificing power generation of at least some solar panels). In FIG. 9A, the solar panel arrays 711 are shown with shading in the first position to indicate that the solar panel arrays 711 are located in the first position in this example of FIG. 9A. A portion of the second position that does not overlap with the first position is shown in FIG. 9A with dashed outlines of solar panel arrays to show that, when the solar panel arrays 711 are moved to those respective positions, they can accommodate the solar panel arrays in a configuration sufficient for solar power generation (e.g., sufficient length, width, panel area, panel spacing, array spacing, etc.).

FIG. 9B shows the solar panel arrays 711 in the second position. For example, the solar panel arrays 711 may be moved from the first position (such as shown in FIG. 9A) to the second position (such as shown in FIG. 9B). As shown in this second position, the solar panel arrays 711 are arranged for solar power generation. The solar panel arrays 711 are shown with shading in the second position to indicate that the solar panel arrays 711 are located in the second position in this example of FIG. 9B. A portion of the first position that does not overlap with the second position are shown in FIG. 9B with dashed outlines of solar panel arrays to show that, when the solar panel arrays 711 are moved to those respective positions, they can also accommodate the solar panel arrays in a configuration sufficient for solar power generation.

With respect to FIG. 9A and FIG. 9B, the plurality of solar panel arrays 711 may correspond to the solar panel arrays 111 described with respect to FIG. 1, the solar panel arrays 211 described with respect to FIG. 2, FIG. 3, and/or FIG. 4, and/or solar panel arrays referenced elsewhere herein. Any of the features described with respect to the solar panel systems 100, 200, 300, and/or 400 may correspond to elements in the solar panel system 700. For example, inverter 102, battery 103, and/or output 104 in the solar power system 100 may correspond to similarly numbered inverter 702, battery 703, and/or power output 704 in the solar power system 700, and descriptions of such elements and/or features regarding FIG. 1 are incorporated by reference here in the solar power system 700 of FIG. 9A and FIG. 7B. Similarly, the solar panel arrays 711 may be connected in series or in parallel via one or more connections 721 and/or 722, via one or more connection elements 731 and/or 732, and/or via other electrical equipment, such as described with respect to the connections 121 and/or 122, the connection elements 131 and/or 132, and/or the other electrical equipment in FIG. 1, incorporated by reference here in the solar power system 700 of FIG. 9A and FIG. 7B. At least some of the connections may comprise conduit (e.g., electrical conduit) and/or electrical wiring. The conduit may surround electrical wiring. For example, one or more wires and/or cables may be placed within the conduit. Additionally or alternatively, at least some of the connections may comprise electrical wiring without conduit, such as wiring that may be at least partially exposed and/or that may be buried under ground. For example, off-array wiring may be used that may be buried underground or that may otherwise be inaccessible at the location of the solar panel system 700. Electrical wiring may enable the flow of electricity from components of the solar panel system 700 to the power output 704. The conduit may comprise underground electrical conduit and/or aboveground electrical conduit. For example, a main combiner box, such as one or more of the connection elements 231 and/or 232, may be coupled to the inverter 702 via conduit (e.g., underground electrical conduit). The conduit may be installed underneath (e.g., underground electrical conduit) or adjacent (e.g., parallel to, such as in above ground conduit) at least one of the connectors 800 (e.g., the connector(s) 800 closest to the inverter 702). The conduit may extend approximately as long as path covered by the connectors 800, in between each connecting mechanism 770, and/or at least as long as a distance between a location of a main combiner box when the main combiner box is located at the first portion and a location of the main combiner box when the main combiner box is located at the second portion or at an N^{th} portion (e.g., if the N^{th} portion is further from the first portion than the distance between the second portion and the first portion). In at least some examples, the inverter 702 may be located at a fixed position. Conduit may be coupled (or couplable) to the inverter 702 at fixed positions that may comprise: at least a portion of conduit coupled to one or more connection elements (e.g., 731 and/or 732) at a first position, and at least a portion of conduit coupled (or couplable) to one or more connection elements (e.g., 731 and/or 732) at a second position (or at an N^{th} position).

Wiring/cables/electrical connector(s) that couple the inverter 702 to a main connection element (e.g., one or more of connection elements 231 and/or 232) may be disconnected to allow movement of the solar panel arrays 711 to a different position (e.g., first/second/N^{th} position). Wiring/cables/electrical connector(s) may be recoupled to the inverter 702 after movement of the plurality of solar panel arrays 711 to the different position. In this manner, the one or more connection elements (e.g., 231 and/or 232), including the main connection element, may move along with the plurality of solar panel arrays 711, whereas the inverter 702 may remain stationary. In at least some examples, one or more connection elements may be stationary. For example, one or more stationary connection elements may be coupled/decoupled to the solar panel arrays 711 after/before movement of the solar panel arrays. The inverter 702 may be located at a fixed location, approximately in between the first position and an N^{th} position (or the second position if N equals two), and may be coupled to an electric utility grid and/or a home/building that may use electricity generated by the solar power system 700 at the power output 704. As described herein, power may be transferred from a main connection element to the inverter 702 within electrical conduit (e.g., underground electrical conduit) which may provide increase safety around the solar power system 700, for example, by reducing potential exposure of humans and/or animals to potentially dangerous levels of power. Such a configuration may additionally facilitate movement of the plurality of solar panel arrays 711 between the first/second/N^{th} positions, for example, by avoiding a need to include excess wiring/cables above ground that corresponds to the length of the connectors 800 (e.g., if installed on the system 700) and/or the length of the distance between the furthest connecting mechanisms 770 (e.g., in a linear direction parallel to the connectors 800). As described further herein, the solar panel array system 700 may cover land comprising any amount of area, and the coverage of the solar panel array system may be extended to any additional size, for example, by adding connecting mechanisms 770, connecting connectors 800 to the connecting mechanisms 770, and adding additional electrical conduit to couple the inverter 702 to a main connection element at its further location from the inverter 702. Additionally or alternatively, while shown as a single inverter in the system 700, the inverter 702 may comprise a plurality of inverters. In such a system comprising a plurality of inverters as the inverter 702, an inverter may be located adjacent and/or nearby one or more positions of the system 700. For example, an inverter may be located within or nearby a plurality of (e.g., each of) the first, second, and/or N^{th} positions. Additional electrical equipment may be included in the system 700, such as fuses, transformers, switches, and the like, to facilitate safe and reliable transfer and conversion of electrical power from the solar panels of the solar panel arrays 711 to the power output 704.

The plurality of solar panel arrays 711 may comprise any quantity of solar panel arrays. Any of the plurality of solar panel arrays 711 may comprise any quantity of solar panels, such as the solar panels 101 described with respect to FIG. 1 incorporated by reference here in the solar power system 700 of FIG. 9A and FIG. 7B. At least some solar panels in the plurality of solar panel arrays 711 may be spaced apart from an adjacent solar panel within an array of solar panels, such as shown in FIG. 9A and FIG. 7B, or may be placed adjacent to another solar panel without a noticeable space/gap between the solar panels such as shown in FIG. 1. The plurality of solar panel arrays 711 may be moved one array at a time, multiple arrays at a time (e.g., such as by using the frame 250 comprising the inter-row joiner 900 coupling multiple arrays), and/or all of the plurality of solar panel arrays 711 together. For example, a plurality of rows of solar panels and/or solar panel arrays may be coupled in a fixed manner (e.g., permanently joined together, such as by the inter-row joiner 900) so as to form a solar panel array 711 that may comprise a plurality of rows of solar panels that may all remain together (e.g., remaining together during movement between positions and/or before/after movement between positions).

Connecting mechanisms 770 and connectors 800 may facilitate movement of the plurality of solar panel arrays 711 between the first position, the second position, and/or an N^{th} position. Each of the plurality of solar panel arrays 711 may comprise a plurality of solar panels 101 mounted on a moveable frame 250 (such as shown in FIG. 2, FIG. 3, and/or FIG. 4), described and shown further herein. The moveable frame 250 may be mounted on a portion of the connecting mechanism 770 (e.g., pedestal 262), for example, if the moveable frame 250 is in a stationary/fixed position (such as during in a power generation configuration). The moveable frame 250 may be mounted on a portion of a connector 800, for example, if the moveable frame 250 is in a movable position (such as during movement between one power generation configuration/location to another). The moveable frame 250 may have a width corresponding to the width of each solar panel array 711. The width W may be determined by any combination of: a land area available for solar power generation, a quantity of solar panels desired for a solar panel array (e.g., based on a quantity of solar power generation desired), a size (e.g., width) of each solar panel of the solar panel array, a (desired) spacing between each solar panel of the solar panel array 711, and/or spacing requirements for use of and/or access to land in between connecting mechanisms 770 and the connectors 800 such as width(s) of various agricultural equipment and/or capability/ies of equipment such as a turning radius and/or whether equipment may have a reverse gear. When the plurality of solar panel arrays 711 are arranged sufficiently spaced apart for a solar panel production configuration, the plurality of solar panel arrays 711 may have a collective length as corresponding to the collective length of the solar panel arrays 711. The length may be determined by any combination of: a land area available for solar power generation, a quantity of solar panel arrays 711 desired (e.g., based on a quantity of solar power generation desired), and/or a (desired) spacing between each solar panel array 711 (e.g., based on land use requirements, such as optimal spacing for crop growth, equipment access, etc.).

When the plurality of solar panel arrays 711 are arranged sufficiently spaced apart for a solar panel production configuration, the solar panel arrays 711 may cover a two-dimensional region (e.g., a portion of land) having an area corresponding to the width and length described above. The system 700 may be configured for connectors 800 to be located parallel relative to each other, for example, to facilitate linear movement of the solar panel arrays 711. While seven connectors 800 and seven connecting mechanisms 770 are shown in both the left and right sides of FIG. 9A, and while six connectors 800 and seven connecting mechanisms 770 are shown in both the left and right sides of FIG. 7B, any quantity of connecting mechanisms 770 and connectors 800 be used with the solar power system 700. The connecting mechanisms 770 and the connectors 800 may be located at opposite ends of the width of the solar panel arrays 711. As another example, another set of connecting mechanisms and connectors (not shown) may be located in between the left and right sides of the solar panel arrays 711. The connecting mechanisms 770 may be spaced apart by a sufficient distance to accommodate various equipment (e.g., farming equipment such as tractors, harvesters, plows, etc.) passing in between the connecting mechanisms 770, such as in a direction parallel to the connecting mechanisms 770. Two sets of connectors 800 may be installed to be parallel to each other so as to permit only linear movement of the solar panel arrays 711.

By configuring the moveable solar panel array systems in the manner described herein, land covering an area configured for solar power generation at some time periods may be used for agricultural purposes (e.g., crops, livestock, etc.) at other time periods in a manner similar to its use prior to an installation of the solar power system. For example, when the solar panel arrays 711 are located in the first position in a solar power generation configuration, non-overlapping land in the second position may be used for agricultural purposes without being obstructed by solar panels. Similarly, when the solar panel arrays 711 are located in the second position in a solar power generation configuration, non-overlapping land in the first position may be used for agricultural purposes without being obstructed by solar panels. Moreover, in any position, after the solar panel arrays 711 have been moved, the connectors 800 may be removed (e.g., and stored locally or offsite), and the land in between each solar panel array 711 may be unobstructed and fully available for agricultural purposes.

In addition to enabling a dual-purpose of land for both solar power generation and agricultural use, the systems and methods described herein may provide additional advantages such as improved case of maintenance and compliance with zoning requirements. For example, by enabling the placement of solar panel arrays 711 to be flexible, via movement of the solar panel arrays 711 on a per-array basis, solar panel arrays 711 that are moveable between connecting mechanisms 770 (e.g., via connectors 800) may enable improved access to solar panels on a solar panel array 711, such as for repair and/or replacement of a solar panel and/or related equipment (e.g., power optimizer(s), microinverter(s), wiring/cables, combiner boxes, fuses, circuit breakers, etc.), by moving the solar panel array 711 requiring service to a location away from other solar panel arrays during the time of servicing/repairing. As another example, solar panel arrays 711 that are moveable between connecting mechanisms 770, and that are moveable via connectors 800, may enable a greater area of land to be used for solar power generation while maintaining compliance with various zoning and/or ordinance requirements that may otherwise restrict solar panel coverage of land, or permanent structures such as rails across the length of a solar power generation area, such as by limiting a percentage and/or a total quantity of land to be covered at any given time with solar panels. The flexible systems and methods described herein may more easily enable compliance with such zoning and/or ordinance requirements while also maximizing land use such as for the dual-purpose of land for both solar power generation and agricultural use.

While FIG. 9A and FIG. 7B are shown with a total area that may accommodate up to six rows of solar panels (e.g., up to six solar panel arrays 711), and with a total of four rows of solar panels (e.g., four solar panel arrays 711) that are movable between different positions, the solar power system 700 may accommodate any quantity of rows of solar panels, and with any quantity of rows of solar panels that may be moveable between different positions. Additionally or alternatively, while FIG. 9A and FIG. 7B are shown with half of the first position overlapping with the second position, and with half of the second position overlapping with the first position, any quantity of a first position may overlap with any quantity of a second (or up to an N^{th} position) such that multiple positions may include at least some solar panels that are in a configuration sufficient for solar power generation in at least some other position.

FIG. 10 shows an example of a solar panel array of a mobile solar panel array system, such as system 100 of FIG. 1. A solar panel array 9211 may be configured to be moveable between a plurality of locations. The solar panel array 9211 in FIG. 10 may correspond to a solar panel array of the plurality of solar panel arrays 111 described with respect to FIG. 1. Any of the features with respect to the solar panel system 100 described and/or shown with respect to FIG. 1 may correspond to elements of FIG. 10. For example, row combiner box 9231 may correspond to the connection element 131 and/or the connection element 132 described with respect to FIG. 1. Connection 9233, shown as one or more wires to a main combiner box in FIG. 10, may correspond to connections to the connection element and/or connections to the inverter 102 and/or battery 103 shown and described with respect to FIG. 1. Moveable frame 9250 may correspond to the moveable frame described (but not shown) with respect to FIG. 1.

The moveable frame 9250 may comprise one or more wheels 9773 shown as part of a connecting mechanism 9770. The one or more wheels 9773 may correspond to one or more wheels and/or friction reducing element(s) as described herein. One or more of the wheels 9773 may comprise a wheel lock and/or movement resistive element. The wheel lock may be configured to resist movement of the moveable frame 9250, for example, when the wheel lock is engaged. The wheel lock may be configured to disable resistance of movement of the moveable frame 9250, for example, when the wheel lock is disengaged.

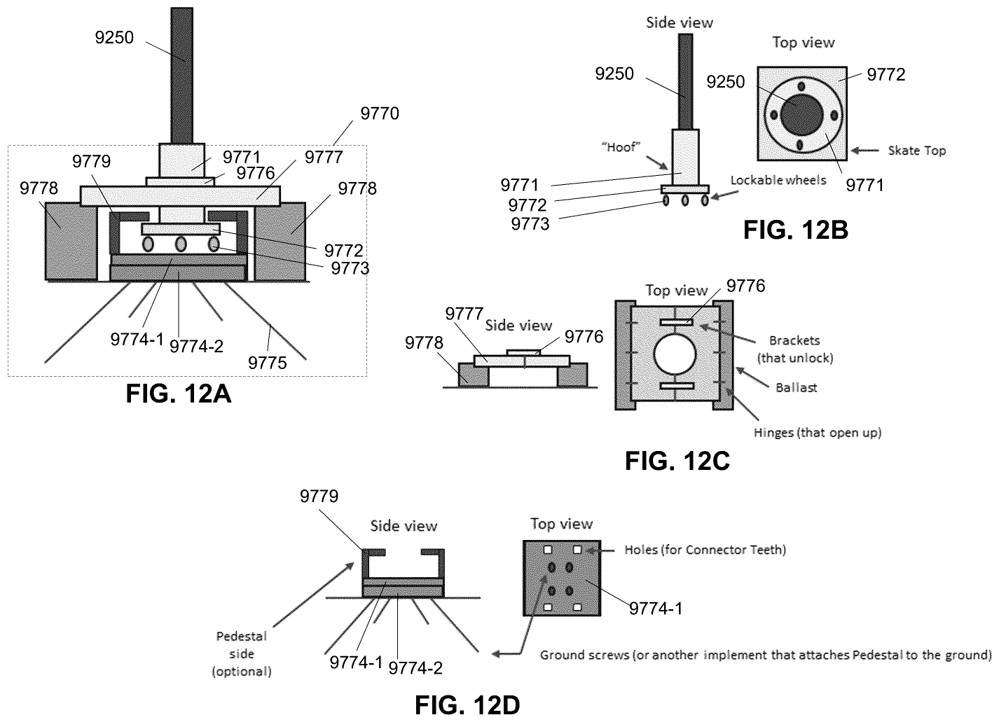

The wheels 9773 may facilitate movement of the solar panel array 9211 between connecting mechanisms 9770 (e.g., forward and/or backward) along moveable connectors 9800 that may be (temporarily) installed along the ground for movement of the solar panel array 9211 between different locations for solar power generation. For example, the solar panel array 9211 may be moved (either separately or in combination with movement of a plurality of solar panel arrays) to be located in a first position (such as shown and described herein with respect to FIG. 9A regarding a plurality of solar panel arrays 711) to any other position(s) such as a second position (such as shown and described herein with respect to FIG. 9B regarding a plurality of solar panel arrays 711) that may be connected via moveable connectors 9800. Each solar panel array 9211 may be moved, for example, after connecting one or more moveable connectors 9800 between locations to/from which the solar panel array is to be moved, disengaging a connecting mechanism 9770 (shown in more detail regarding FIGS. 12A, 12B, 12C, and 12D), unlocking its respective wheel(s) 9773 by disengaging its (optional) wheel lock(s), and disconnecting all wiring/cables that couple the respective solar panel array 9211 to a respective row connection element 9231 (e.g., as shown at element 9233 as a wire coupling the connection element 9231 to an inverter such as the inverter 102 described with respect to FIG. 1). These steps may be performed in any order. For example, disconnecting all wiring/cables may be recommended as an initial step.

As shown in FIG. 10, the solar panel array 9211 may comprise any quantity of solar panels. Four solar panels are shown in FIG. 10, with two pairs separated by a break symbol to indicate that any quantity of additional solar panels may be included in between the two shown pairs of solar panels. That is, the solar panel array 9211 may comprise fewer than, or greater than, the four solar panels shown in FIG. 10. The solar panels of the solar panel array 9211 may be mounted on a moveable frame 9250 of the solar panel array 9211. Solar panel configurations for the solar panel array 9211 may be customized based on site requirements. For example, solar panel configurations may range from completely horizontal (e.g., zero degree tilt), a 15-degree title angle, a 20-degree tilt angle, and/or a 30-degree tilt angle (or any other tilt angle). Additionally or alternatively, the solar panel array 9211 may have its solar panels configured as trackers (e.g., facing cast in the morning and slowly rotating west over the course of the day to track the location of the sun). Solar panels in the solar panel array 9211 may be spaced anywhere relative to each other, such as from less than an inch apart to one or more feet apart (or any other distance), for example, to allow for structural considerations such as wind load, and/or to accommodate the total amount of direct sunlight that may fall on the land beneath the panels (e.g., to help enable certain crop and/or grass/feed growth).

In addition to wheels, or in the alternative to wheels, the moveable frame 9250 described with respect to FIG. 10 may comprise one or more friction reducing elements for facilitating movement of a plurality of solar panel arrays (e.g., 9211) between a first location (e.g., first position) and at least a second location (e.g., second position and/or N^{th} position). In at least some examples, the friction reducing element(s) may comprise the wheels 9773. The wheels may comprise sliding brackets (e.g., similar in style as moveable filing or utility/tool cabinets), ball bearings, and/or the like. In at least some other examples, the friction reducing element(s) may comprise at least one of a bearing and/or a chain that may be coupled to one or more gears. Any other configuration and/or feature may be implemented as the one or more friction reducing elements to facilitate movement of the plurality of solar panel arrays (e.g., 9211).

The moveable frame 9250 may comprise any shape. For example, while the moveable frame 9250 is shown in FIG. 10 as generally comprising three linear portions (e.g., one long portion upon which the panels are mounted, and two side portions extending downward toward respective connecting mechanisms 9770 and moveable connectors 9800), the moveable frame 9250 may comprise additional or alternate portions, such as sides with cross-sections resembling an upside-down V-frame, an upside-down U-frame, or an A-frame, with wheels 9773 on the bottom of two legs on both sides of the moveable frame 9250, and/or truss-like structures along the width of the moveable frame 9250 and/or at the sides of the moveable frame which may provide support for the weight of the solar panels. In at least some examples, the moveable frame 9250 may comprise a shape corresponding to the moveable frame 250 described with respect to FIG. 2. Additionally or alternatively, the moveable frame 9250 may be configured to accommodate solar panels on two sides, and/or to enable one or more solar panels to be moved (e.g., flipped/turned) from one side to another side, which may enable increased solar power production for a longer duration of a day (e.g., as the sun is setting, solar panels having their surface facing away from the sun may be flipped/turned to re-face the sun, to generally track the sun). The moveable frame 9250 may be customized and/or adjusted to any height, for example, to accommodate certain access to land covered by the solar panel array system 100 (e.g., grazing, irrigation, harvesting, seeding, etc.) during a time that the system 100 is configured for solar power generation over that land, and/or to accommodate different crops for different heights throughout a growing season. For example, the moveable frame 9250 may comprise one or more vertical adjustment elements that may comprise at least one of: a spring-loaded notch coupled with a plurality of vertically spaced holes, a turn-dial coupled with gear, and/or a motor coupled with an electronic controller. The moveable frame 9250 may comprise one or more add-on features that may assist with certain agricultural uses, such as hooks, pipes, and/or hoses. At least some moveable frames 9250 (e.g., located at outer rows of the system 100) may comprise additional elements such as hitches and/or attachments for agricultural tools and/or equipment (e.g., seed spreaders, aerators, etc.). The moveable frame 9250 may be configured with one or more gutters and/or other rainwater collection devices which may direct rainwater (e.g., collected from sliding across solar panels) to cisterns, rain barrels, and the like.

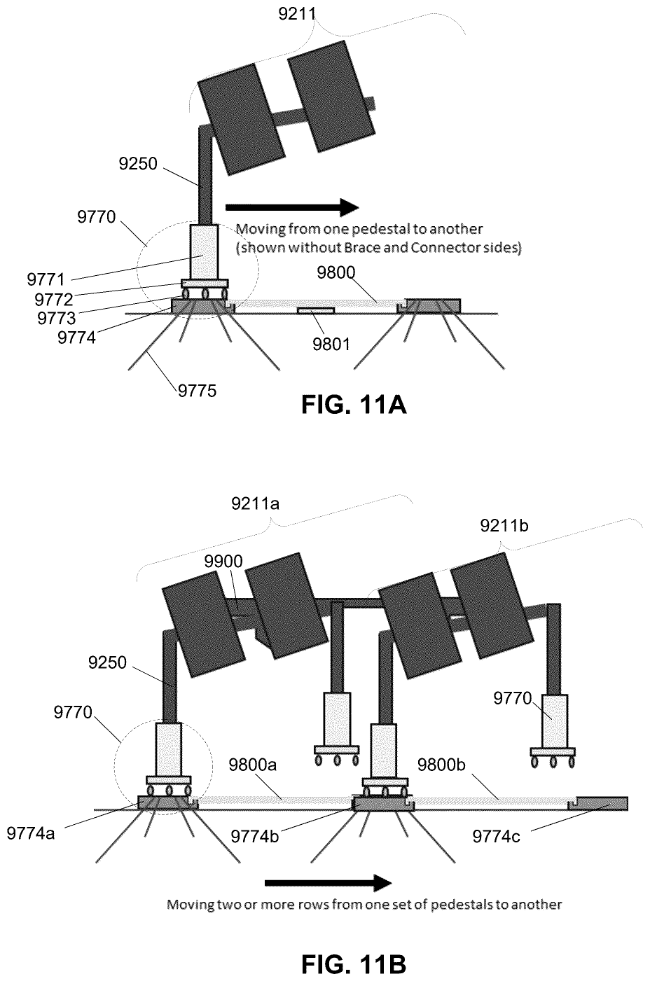

One or more solar panel arrays (e.g., 9211) may comprise one or more attachments configured to facilitate movement of the respective solar panel array(s) (e.g., either separately or in combination with movement of a plurality of solar panel arrays). For example, an inter-row joiner may couple a plurality of solar panel arrays. While an example of an inter-row joiner is shown as inter-row joiner 9900 in FIG. 11B and in FIG. 14, the inter-row joiner may comprise any size and/or shape. The one or more attachments may comprise, for example, at least one of a tractor pull/hitch, a cable, or a motor. For example, solar panel arrays 9211 that may be relatively shorter (and, as a result, lighter) may be moved manually and/or via a crank (e.g., powered manually as a manual crank and/or an electrical crank powered via one or more electrical and/or hydraulic source(s), and/or the like) and/or pulley system. Solar panel arrays 9211 that may be relatively longer (and, as a result, heavier) may be moved using an electrical motor and/or pushed/pulled by a tractor and/or other vehicle. In at least some examples, such as for significantly heavy solar panel arrays 9211, a cable may be used/installed, such as next to at least one of the connecting mechanisms 9770 and/or moveable connectors 9800, whereby each solar panel array 9211 may be (e.g., temporarily) connected to the cable that may further be coupled to an engine that may pull the cable, along with any connected solar panel array(s) 9211, to the desired location.

FIG. 11A shows an example of a connecting mechanism, a moveable connector, and movement of a mobile solar panel array from one location to another location. The solar panel array 9211 may be configured to be moveable between a plurality of locations. The solar panel array 9211 in FIG. 11A may correspond to a solar panel array of the plurality of solar panel arrays 111 described with respect to FIG. 1, and/or the solar panel array 9211 described with respect to FIG. 10. Any of the features with respect to the solar panel system 100 described and/or shown with respect to FIG. 1, and/or any of the features with respect to the solar panel array 9211 described and/or shown with respect to FIG. 10 may correspond to elements of FIG. 11A. For example, the solar panel array 9211 may comprise a moveable frame 9250 coupled to a portion of a connecting mechanism 9770. The moveable frame 9250 may be fit into an adapter 9771, or hoof, that may be placed around a support of moveable frame 9250 for fitting the solar panel arrays into the connecting mechanism 9770. The adapter 9771 may be configured in a variety of different sizes and/or shapes in order to accommodate a variety of difference sizes and/or shapes of the support of the moveable frame 9250. For example, the connecting mechanism may be adapted to fit different sizes and/or shapes of supports of moveable frames 9250 by using an adapter 9771 configured to fit a particular size and/or shape of a support of the moveable frame 9250.

The connecting mechanism 9770 may comprise a base 9772. The base 9772 may be referred to as a skate top, plate, and the like. The base 9772 may operate as a structure that completely or partially supports the moveable frame 9250 of the solar panel array 9211 (e.g., at one of its ends and/or at another location along a length of the moveable frame 9250) and/or that facilitates movement of the solar panel 9211 across a moveable connector 800 that connects to a portion of another connecting mechanism 9770. The moveable connector 9800 may comprise and/or may be coupled to a spacer 9801 that may reduce bend in the moveable connector 9800 when the solar panel array 9211 is moved along the moveable connector 9800 from one connecting mechanism 9771 to another connecting mechanism. The moveable connector 9800 may comprise groves, for example, for wheels to sit within and/or to roll on. The base 9772 may comprise one or more wheels 9773 and/or other friction reducing elements on the underside of the base 9772. The connecting mechanism 9770 may comprise a pedestal 9774 upon which the one or more wheels 9773 and/or other friction reducing elements may rest, for example, when the solar panel array 9211 is configured in a stationary position. The pedestal 9774 (and/or one or more other portions of the connecting mechanism 9770) may be secured to a surface (e.g., ground, grass, pavement, and/or any other surface) using one or more screws 9775, bolts, and/or the like. The pedestal 9774 may comprise groves, for example, for wheels to sit within and/or to roll on. While FIG. 11A shows a moveable connector 9800 without a brace or connector sides, such structures may be included with the moveable connector (e.g., to improve durability and structure integrity of the connecting mechanism 9770 and/or to prevent lateral movement of the solar panel array 9221 off of the moveable connector 9800.

FIG. 11B shows an example of connecting mechanisms at opposite ends of solar panel arrays, moveable connectors, and movement of a plurality of mobile solar panel arrays. The solar panel arrays 9211a and 9211b in FIG. 11B may correspond to the solar panel array 9211 described with respect to FIG. 10 and/or FIG. 11A. Any of the features with respect to the solar panel system 100 described and/or shown with respect to FIG. 1, and/or any of the features with respect to the solar panel array 9211 described and/or shown with respect to FIG. 10 and/or with respect to FIG. 11A may correspond to elements of FIG. 11B. For example, FIG. 11B shows two moveable connectors 9800 (e.g., 9800a and 9800b) connecting in between three pedestals 9774 (e.g., 9774a, 9774b, and 9774c) of respective connecting mechanisms. In the configuration shown in FIG. 11B, a first solar panel array 9211a may be moved from/to a first pedestal 9774a to/from a second pedestal 9774b along a moveable connector 9800a. A second solar panel array 9211b may be moved from/to the second pedestal 9774b to/from a third pedestal 9774c along a moveable connector 9800b. While only two moveable connectors and three pedestals are shown, any quantity of moveable connectors may be used (e.g., N, where N is a positive integer) for movement between any quantity of pedestals (e.g., N+1, where N is a positive integer corresponding to a minimum number of moveable connectors). One or more (e.g., each) pedestal may be a portion of a respective connecting mechanism 9770, described in further detail with respect to FIGS. 12A, 12B, 12C, and 12D.

FIG. 12A shows an example of a connecting mechanism to secure a frame of a mobile solar panel array. As described herein, a connecting mechanism 9770 may comprise some or all of the elements shown in FIG. 12A, excluding a moveable frame 9250. A portion of a moveable frame 9250 of a solar panel array is shown in FIG. 12A and may correspond to the moveable frame 9250 of the solar panel array 9211 described with respect to FIG. 10 and in FIG. 11A, and may correspond to a portion of the moveable frame 9250 of the solar panel array 9211a and 9211b described with respect to FIG. 11B. Any of the features with respect to the solar panel system 100 described and/or shown with respect to FIG. 1, and/or any of the features with respect to the solar panel array 9211 described and/or shown with respect to FIG. 10 and/or with respect to FIG. 11A, and/or any of the features with respect to the solar panel arrays 9211a and 9211b described with respect to FIG. 11B may correspond to elements of FIGS. 12A, 12B, 12C, and/or 12D. For example, the moveable frame 9250 may be fit into an adapter 9771, or hoof, that may be placed around a support of moveable frame 9250 for fitting the solar panel arrays into the connecting mechanism 9770. A brace 9776 may be inserted onto and/or around the adapter 9771, for example, to secure the adapter to one or more other portions of the connecting mechanism 9770. The brace 9776 may abut, float above, and/or attach to one or more brackets 9777. The bracket(s) 9777 may be attached and/or coupled to one or more ballasts 9778. In at least some examples, cabling may be used in place of or in addition to bracket(s) 9777 to assist in securing the connecting mechanism 9770 to the ground and/or to one or more ballasts 9778. The ballast(s) 9778 may provide a mass that, by gravitational force, may help to secure a solar panel array comprising the moveable frame 9250 from lifting upward, such as due to high winds and/or other forces. The ballasts 9778 may be configured to be a sufficient weight so as to counteract upward force that may be generated from high winds (e.g., at least up to, if not exceeding, eighty-five miles per hour). The ballasts may be made of cement, metal, and/or any other durable and relatively heavy material. The ballasts 9778 may be moveable or may be sufficiently weighted so as to prevent their movement. The pedestal 9774 may comprise a plurality of portions, such as a top portion 9774 and/or a bottom portion 9774-2. The top portion 9774-1 may provide a surface for wheels 9773 of a base 9772 to rest while a solar panel array is in a substantially stationary position. In at least some examples, the bottom portion 9774-2 may be mounted at or below ground level. For example, if the bottom portion 9774-2 is below ground level, the top surface of the top portion 9774-1 may be approximately at ground level. In such a configuration in which at least a portion of the pedestal 9774 (e.g., at least a portion of the bottom portion 9774-2) is below ground level, the land around the connecting mechanism 9770 may be made more easily accessible and/or available for agricultural use by not having components of the connecting mechanism obstructing equipment and/or other access to the surrounding land. Additionally or alternatively, wheels, rollers, and/or springs (not shown) may be placed along one or more sides of the base 9772, for example, so as to reduce friction and enable movement along the connecting mechanism 9770 and/or along the moveable connectors 9800. The bottom portion 9774-2 may rest on the ground or other surface and may be secured by one or more screws 9775, bolts, and/or the like. The pedestal 9774 may be made of metal, composite material, and/or any other material of sufficient strength and durability to withstand the weight and movement of solar panel arrays.

FIG. 12B shows an example side view and top view of a portion of a connecting mechanism comprising an adapter, a base, and wheels. While not all portions of the connecting mechanism 9770 of FIG. 12A are shown in FIG. 12B, one or more elements of FIG. 12B may be included in the connecting mechanism 9770 of FIG. 12A. For example, in FIG. 12B, the portion of the moveable frame 9250 of a solar panel array is shown, in both a side view and a top view, circumferentially surrounded by an adapter 9771. The adapter 9771 may be secured to the base 9772, for example, with bolts, screws, and/or the like (e.g., as shown in the top view with four substantially equally spaced bolts/screws). The underside of the base 9772 may comprise wheels 9773 that (optionally) may be lockable.

FIG. 12C shows an example side view and top view of a portion of a connecting mechanism comprising ballasts and brackets. While not all portions of the connecting mechanism 9770 of FIG. 12A are shown in FIG. 12C, one or more elements of FIG. 12C may be included in the connecting mechanism 9770 of FIG. 12A. As shown in the top view of FIG. 12C, the bracket 9777 may be configured to fit a portion of the moveable frame 9250 of a solar panel array through a center of a pair of brackets 9777. The bracket(s) 9777 may comprise hinges, for example, to secure the bracket(s) to the ballast(s) 9778 and/or to facilitate rotatable movement of the bracket(s) 9777 to allow for securing and releasing of a portion of the moveable frame 9250 of the moveable solar panel array. One or more braces 9776 may be applied to assist in securing the solar panel array in a substantially stationary position. The brace(s) 9776 may connect to the bracket(s) 9777 to assist in securing the solar panel array in a substantially stationary position.

FIG. 12D shows an example side view and top view of a portion of a connecting mechanism comprising a pedestal and side pieces. While not all portions of the connecting mechanism 9770 of FIG. 12A are shown in FIG. 12D, one or more elements of FIG. 12D may be included in the connecting mechanism 9770 of FIG. 12A. As shown in the side view of FIG. 12D, the pedestal 9740 (e.g., comprising top portion 9774-1 and bottom portion 9774-2) may be coupled to and/or may comprise as integral elements one or more side and/or top elements 9779. The side and/or top elements may be generally referred to as side pieces 9779. The side pieces 9779 may be configured to restrict, limit, and/or prevent movement of the solar panel array (e.g., via connection with a support portion of the moveable frame 9250) in a lateral direction (e.g., left and/or right to the direction of movement along the moveable connector 9800), for example, by at least partially enclosing the base 9772. Additionally or alternatively, the side pieces 9779 may be configured to restrict, limit, and/or prevent movement of the solar panel array (e.g., via connection with a support portion of the moveable frame 9250) in an upward direction (e.g., away from the surface/ground), such as due to high wind and/or other upward force. As shown in the top view of FIG. 12D, the pedestal 9774 (e.g., at the top portion 9774-1) may comprise one or more holes, other cutouts, and/or structures that may be configured for insertion of a portion of moveable connectors 9800 and/or for insertion of one or more screws, bolts, and the like. For example, one or more holes in the pedestal 9774 may be configured to receive a screw, bolt, and/or the like for purposes of securing the pedestal 9774 to a surface such as the ground. One or more holes in the pedestal may receive a protruded portion of a moveable connector 9800, for example, to facilitate a connection between the pedestal 9774 and the respective moveable connector 9800 so that these elements may remain connected for movement of one or more solar panel arrays from one connecting mechanism 9770 to another connecting mechanism via an interconnected moveable connector 9800.

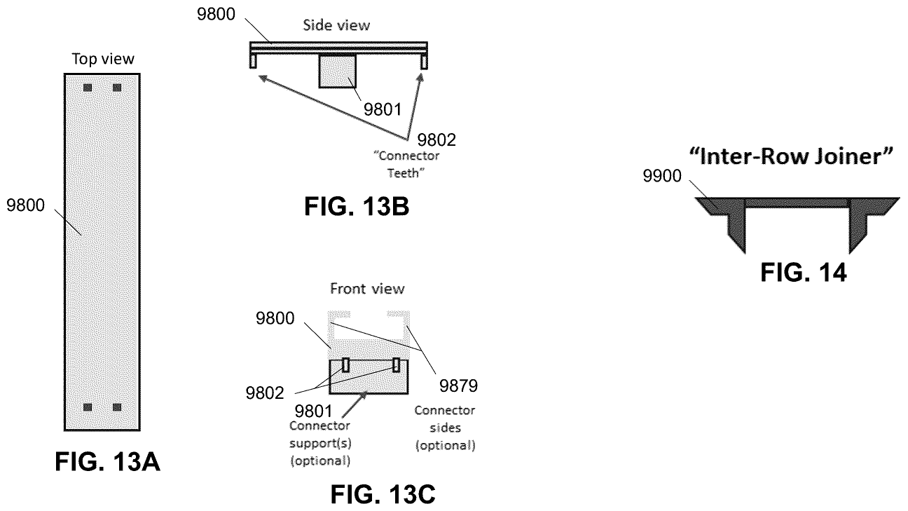

FIG. 13A shows an example top view of a moveable connector. The moveable connector 9800 in FIG. 13A (and in FIG. 13B and FIG. 13C) may correspond to the moveable connector described herein with respect to FIG. 10, FIG. 11A, FIG. 11B (e.g., 9800a and 9800b), FIG. 12A, FIG. 12B, FIG. 12C, and FIG. 12D. The moveable connector 9800 may comprise an elongated, rectangular shape such as shown in FIG. 13A, or any other shape (e.g., tubular, curved, square). The moveable connector 9800 may be made of a solid material (e.g., metal), may be made of a composite material, and/or may be hollow. The moveable connector 9800 may comprise one or more ridge, cutouts, grooves, indents, and/or protrusions on the ends (e.g., the short sides) to facilitate (temporary) connection with pedestals 9774 of a connecting mechanism 9770.

FIG. 13B shows an example of a side view of a moveable connector. The moveable connector 9800 may comprise a spacer 9801. The spacer 9801 may be made of a same or a different material relative to the moveable connector 9800. The spacer 9801 may comprise a substantially flat upper surface, and/or may comprise a surface that is complementary to the lower surface of the moveable connector 9800 to facilitate coupling the spacer 9801 with the moveable connector 9800 along a level surface. The spacer 9801 may comprise a substantially flat or angular lower surface to facilitate placement on the ground or other surface in a manner that provides a level top surface for the moveable connector 9800. Different spacers may be used for different surface conditions (e.g., flat, angled, rough, smooth, etc.). For example, along surfaces that are relatively smooth and/or slippery, the spacer 9801 may comprise one or more friction elements on its lower surface. As another example, for surfaces that are sloped (e.g., in a consistent or changing slope along a length), the spacer 9801 may comprise one or more slopes on its lower surface and/or the spacer 9801 may be adjustable to one or more slopes (e.g., compressible material such as foam, mechanical adjustment element(s) to adjust slope, etc.). The moveable connector 9800 may comprise connector teeth 9802, as shown in FIG. 13B. Additionally or alternatively, the moveable connector 9800 may comprise one or more ridge, cutouts, grooves, indents, and/or protrusions on or near the sides and/or edges to facilitate (temporary) connection with pedestals 9774 of a connecting mechanism 9770.

FIG. 13C shows an example of a front/back view of a moveable connector. The moveable connector 9800 is shown in FIG. 13C with the spacer 9801 shown as a connector for optional support under the moveable connector 9800. As shown in FIG. 13C, the moveable connector 9800 may comprise the connector teeth 9802, as also shown in FIG. 13B in the side view of the moveable connector 9800. The moveable connector 9800 may comprise one or more connector sides 9879. The connector side(s) 9879 may extend along one or more sides and/or top portion(s) of the moveable connector 9800 as shown in FIG. 13C. Additionally or alternatively the connector side(s) 9879 may take the form of any shape and/or size. In at least some examples, the connector side(s) 9879 may correspond to the shape of the side pieces 9779 of the pedestal 9740 of the connecting mechanism 9770, such as shown in FIG. 12A and FIG. 12D, to facilitate smooth movement of the solar panel array from a connecting mechanism 9770 (e.g., comprising pedestal 9774 in FIG. 11B) to the moveable connector 9800 (e.g., 9800a in FIG. 11B), and then to another connecting mechanism 9770 (e.g., comprising pedestal 9774b) at the opposite side of the moveable connector 9800.

FIG. 14 shows an example of an inter-row joiner for connecting a plurality of solar panel arrays. The inter-row joiner 9900 may correspond to the inter-row joiner 9900 shown and described with respect to FIG. 11B. The inter-row joiner 9900 may comprise a structure that is configured to couple two or more rows of solar panel arrays, for example, so that they may be moved together (e.g., using a same force to move the rows of solar panel arrays connected by the inter-row joiner 9900). The inter-row joiner 9900 may be made of any material, such as metal, plastic, composite material, and the like. In at least some examples, the inter-row joiner 9900 may comprise a same or similar material as the moveable frame 9250. While FIG. 11B shows the inter-row joiner 9900 connecting two solar panel arrays (e.g., 9211a and 9211b), any quantity of solar panel arrays may be connected to one or more inter-row joiner 9900 (which may be modified for any size and/or shape to accommodate the respective quantity of solar panel arrays to be connected).

Returning to FIGS. 9A-9B, in an example wherein the connectors 800 may comprise moveable connectors 9800 (e.g., such as described with respect to FIGS. 10-14), pedestals 9774 of connecting mechanisms 9770 may be installed in the ground using one or more securing mechanisms. For example, the pedestals 9774 may be bolted in a manner similar to railroad tics. Additionally or alternatively, pedestals 9774 may be hammered into the soil. Additionally or alternatively, pedestals 9774 may be secured via concrete, rebar, screws, bolts/nuts, ground posts, weighted ballasts, and/or any combination thereof. Row length of the solar panel arrays 9711 may be configurable on site, for example, to cover any area that is desired for solar power generation and some other land use. While pedestals 9774 may be installed for long-term and/or permanent placement, the use of moveable connectors 9800 to enable movement of the solar panel arrays 9711 may enable movement of the solar panel arrays 9711 without damage and/or with minimal or no negative impact to land. Additionally or alternatively, the use of moveable connectors 9800 to enable movement of the solar panel arrays 9711 may enable additional use of the land underneath the moveable connectors 9800 when the moveable connectors are removed from the land (e.g., after the solar panel array(s) 9711 is/are moved to a desired location such as for solar power generation). In contrast to the solar power system 9700, a solar power system that may be mobilized with wheels but without the benefit of moveable connectors 9800 as described herein may damage land (e.g., destroy crops, damage grass, leave tracks, etc.) due to the relatively heavy nature of solar panel arrays and related equipment. However, by using moveable connectors 9800 as described herein, land between the moveable connectors 9800 and land outside of the moveable connectors 9800 (e.g., to the left of the left-most moveable connector 9800 and/or to the right of the right-most moveable connector 9800) may be undisturbed by the movement of solar panel arrays 9711. As a result, systems and methods described herein may provide advantages of a flexible solar power generation system having minimal or no negative impact on land caused by movement of solar panel arrays, and/or by providing a flexible system in which moveable connectors 800 may be removed when not in used to allow further access to land such as for agricultural purposes.

The solar panel arrays 9711 may be moved from one connecting mechanism 9770 to another connecting mechanism 9770 by the following steps. On both sides of the solar panel arrays 9711, moveable connectors 9800 may be placed in between each connecting mechanism 9770 that forms a pathway from the starting location of the solar panel array 9711 to the destination location for the solar panel array 9711. For example, two or more moveable connectors may be placed to connect three connecting mechanisms 9770 to form a pathway for the solar panel array 9711. Braces 9776 may be opened and/or unlocked at each end of a solar panel array 9711 that is to be moved. Wheels 9773, of the bases 9772 (from each connecting mechanism 9770 under a solar panel array 9711 that is to be moved), if locked, may be unlocked. Wiring of power connections from the solar panel array and/or associated electronic equipment, such as addressed herein, may be disconnected. Optionally, inter-row joiners 9900 may be connected to two or more solar panel arrays 9711 (e.g., to facilitate movement of a corresponding two or more solar panel arrays 9711 together).

A solar panel system may comprise a plurality of features. The solar panel system may comprise, for example, a plurality of solar panels, a frame configured to support the plurality of solar panels, and a wheel assembly configured to be attachable to the frame. The wheel assembly may comprise: a wheel configured to rotate about an axis; a wheel bracket attached to the wheel in a manner that facilitates rotation of the wheel about the axis; a shaft attached to the wheel bracket; and a pin extending through at least one side of the shaft and configured to rotatably attach the shaft to the frame. The pin may be configured to rotatably attach the shaft to the frame in a manner that may be configured to cause the wheel to: engage a first surface in a manner that lifts the frame upon rotation of the shaft in a first direction; and disengage from the first surface in a manner that lowers the frame upon rotation of the shaft in a second direction, opposite from the first direction. The frame may comprise a leg (or a plurality of legs, such as two legs, four legs, or any other quantity of legs). The leg may comprise an attachment portion that is configured to attach the leg to the wheel assembly. The leg may further comprise at least one leg bracket coupled to the attachment portion. The at least one leg bracket may comprise a cavity that may be configured to receive the pin in a manner that may be configured to cause the wheel to: engage the first surface in a manner that lifts the leg of the frame off of a ground surface upon the rotation of the shaft in the first direction; and disengage the first surface in a manner that lowers the leg of the frame onto the ground surface upon rotation of the shaft in the second direction. The solar panel system may further comprise a locking pin configured to secure the wheel assembly to at least one of: the leg, the attachment portion, a first leg bracket of the at least one leg bracket that comprises the cavity, or a second leg bracket of the at least one leg bracket. The wheel assembly may further comprise a lever configured to engage the shaft to facilitate at least one of: the rotation of the shaft in the first direction, or the rotation of the shaft in the second direction. The solar panel system may further comprise a rail (or a plurality of rails such as two rails, three rails, or any quantity of rails). The rail may comprise the first surface and may be configured to facilitate horizontal movement of the frame via rotation of the wheel along the first surface. The wheel bracket may comprise a first side and a second side, wherein the wheel may be located in between the first side and the second side of the wheel bracket, and wherein the first side and the second side of the wheel bracket may extend beyond a thickness of the wheel and along respective first and second edges of the first surface, so as to assist in positioning of the wheel along the first surface. The solar panel system may further comprise a pedestal configured to: support a leg of the frame, and be attachable to the leg of the frame via a securing mechanism to prevent movement of the frame. The wheel assembly may be a first wheel assembly configured to be attachable to the frame at a first side of the frame, and the solar panel system may further comprise a second wheel assembly configured to be attachable to the frame at a second side of the frame. The plurality of solar panels may comprise a plurality of rows of solar panels, wherein the frame may comprise an inter-row joiner configured to facilitate coordinated movement of the plurality of rows of solar panels. The solar panel system may comprise any one or more features described herein.

A wheel assembly for a solar panel system may comprise one or more features. For example, the wheel assembly may comprise: a wheel configured to rotate about an axis; a wheel bracket attached to the wheel in a manner that facilitates rotation of the wheel about the axis; a shaft attached to the wheel bracket; and a pin extending through at least one side of the shaft. The pin may be configured to rotatably attach the shaft to a frame of the solar panel system in a manner that may be configured to cause the wheel to: engage a first surface in a manner that lifts the frame upon rotation of the shaft in a first direction; and disengage from the first surface in a manner that lowers the frame upon rotation of the shaft in a second direction, opposite from the first direction. The wheel assembly may further comprise a lever configured to engage the shaft to facilitate at least one of: the rotation of the shaft in the first direction, or the rotation of the shaft in the second direction. The wheel bracket may comprise a first side and a second side, wherein the wheel may be located in between the first side and the second side of the wheel bracket, and wherein the first side and the second side of the wheel bracket may extend beyond a thickness of the wheel and along respective first and second edges of the first surface, so as to assist in positioning of the wheel along the first surface. The pin extending through the at least one side of the shaft may comprise the pin extending through a first side of the shaft and the pin extending through a second side of the shaft to configure the wheel assembly for at least one of: capable attachment to either a first side of the solar panel system or a second side of the solar panel system; or capable attachment to the solar panel system in either a first direction or a second direction. The wheel assembly may further comprise a cavity configured to receive a locking pin to secure the wheel assembly to the solar panel system. The wheel may comprise a substantially flat surface for engagement of the first surface, wherein the wheel assembly may further comprise, extending through both the wheel and the wheel bracket to facilitate the rotation of the wheel about the axis, at least one of a bolt, pin, or roller. The wheel assembly may comprise any one or more features described herein.

A method of moving a solar panel system may comprise one or more steps. For example, the method may comprise: attaching a wheel assembly to a first side of a frame supporting a plurality of solar panels; rotating the wheel assembly in a first direction such that a wheel of the wheel assembly engages a first surface; continue the rotating of the wheel assembly in the first direction at least until the first side of the frame supporting the plurality of solar panels is lifted; after the first side of the frame supporting the plurality of solar panels is lifted, applying a locking mechanism to prevent further rotation of the wheel assembly; and after the applying the locking mechanism, applying a force to move the frame, via rotation of the wheel along the first surface, from a first location to a second location. The wheel assembly may be a first wheel assembly and the locking mechanism may be a first locking mechanism. The method may further comprise: attaching a second wheel assembly to a second side of the frame supporting the plurality of solar panels; rotating the second wheel assembly such that a wheel of the second wheel assembly engages a second surface; continue the rotating of the second wheel assembly at least until the second side of the frame supporting the plurality of solar panels is lifted; and after the second side of the frame supporting the plurality of solar panels is lifted, applying a second locking mechanism to prevent further rotation of the second wheel assembly. Applying the force to move the frame from the first location to the second location may be after applying the second locking mechanism. Movement of the frame from the first location to the second location may comprise rotation of the wheel of the first wheel assembly along the first surface and rotation of the wheel of the second wheel assembly along the second surface. The first surface and the second surface may be different portions of a same planar surface. The first surface may comprise a surface of a first rail via which the wheel of the first wheel assembly may be configured to move along. The second surface may comprise a surface of a second rail via which the wheel of the second wheel assembly may be configured to move along. The method may further comprise: after movement of the frame from the first location to the second location, disengaging the locking mechanism to enable rotation of the wheel assembly; rotating the wheel assembly in a second direction, different from the first direction, such that the wheel of the wheel assembly disengages from the first surface; continuing the rotating of the wheel assembly in the second direction at least until the first side of the frame supporting the plurality of solar panels is lowered; and after the first side of the frame supported the plurality of solar panels is lowered, removing the wheel assembly from the first side of the frame supporting the plurality of solar panels. The method may comprise any one or more steps described herein.

Various aspects described herein may be embodied as a system, a method, an apparatus, or as one or more computer-readable media storing computer-executable instructions (e.g., such as instructions for solar panel rotation/tracking and/or automated movement of solar panels and/or solar panel arrays). Aspects of the disclosure have been described in terms of example embodiments. Other embodiments, modifications, and/or variations within the scope and spirit of the appended claims will be evident to persons of ordinary skill in the art. For example, one or more of the steps depicted in the example figures may be performed in a different order, one or more steps described with respect to one figure may be used in combination with one or more steps described with respect to another figure, and/or one or more described steps may be optional.

1. A solar panel system comprising:
a plurality of solar panels;
a frame configured to support the plurality of solar panels; and
a wheel assembly configured to be attachable to the frame, wherein the wheel assembly comprises:
a wheel configured to rotate about an axis;
a wheel bracket attached to the wheel in a manner that facilitates rotation of the wheel about the axis;
a shaft attached to the wheel bracket; and
a pin extending through at least one side of the shaft and configured to rotatably attach the shaft to the frame in a manner that is configured to cause the wheel to:
engage a first surface in a manner that lifts the frame upon rotation of the shaft in a first direction; and
disengage from the first surface in a manner that lowers the frame upon rotation of the shaft in a second direction, opposite from the first direction.

2. The solar panel system of claim 1, wherein the frame comprises a leg, and wherein the leg comprises an attachment portion that is configured to attach the leg to the wheel assembly.

3. The solar panel system of claim 2, wherein the leg further comprises at least one leg bracket coupled to the attachment portion, and wherein the at least one leg bracket comprises a cavity that is configured to receive the pin in a manner that is configured to cause the wheel to:
engage the first surface in a manner that lifts the leg of the frame off of a ground surface upon the rotation of the shaft in the first direction; and
disengage the first surface in a manner that lowers the leg of the frame onto the ground surface upon rotation of the shaft in the second direction.

4. The solar panel system of claim 3, further comprising a locking pin configured to secure the wheel assembly to at least one of: the leg, the attachment portion, a first leg bracket of the at least one leg bracket that comprises the cavity, or a second leg bracket of the at least one leg bracket.

5. The solar panel system of claim 1, wherein the wheel assembly further comprises a lever configured to engage the shaft to facilitate at least one of: the rotation of the shaft in the first direction, or the rotation of the shaft in the second direction.

6. The solar panel system of claim 1, further comprising a rail, wherein the rail comprises the first surface and is configured to facilitate horizontal movement of the frame via rotation of the wheel along the first surface.

7. The solar panel system of claim 1, wherein the wheel bracket comprises a first side and a second side, wherein the wheel is located in between the first side and the second side of the wheel bracket, and wherein the first side and the second side of the wheel bracket extend beyond a thickness of the wheel and along respective first and second edges of the first surface, so as to assist in positioning of the wheel along the first surface.

8. The solar panel system of claim 1, further comprising a pedestal configured to: support a leg of the frame, and be attachable to the leg of the frame via a securing mechanism to prevent movement of the frame.

9. The solar panel system of claim 1, wherein the wheel assembly is a first wheel assembly configured to be attachable to the frame at a first side of the frame, and wherein the solar panel system further comprises a second wheel assembly configured to be attachable to the frame at a second side of the frame.

10. The solar panel system of claim 1, wherein the plurality of solar panels comprises a plurality of rows of solar panels, and wherein the frame comprises an inter-row joiner configured to facilitate coordinated movement of the plurality of rows of solar panels.

11. A wheel assembly for a solar panel system, wherein the wheel assembly comprises:
a wheel configured to rotate about an axis;
a wheel bracket attached to the wheel in a manner that facilitates rotation of the wheel about the axis;
a shaft attached to the wheel bracket; and
a pin extending through at least one side of the shaft and configured to rotatably attach the shaft to a frame of the solar panel system in a manner that is configured to cause the wheel to:
engage a first surface in a manner that lifts the frame upon rotation of the shaft in a first direction; and
disengage from the first surface in a manner that lowers the frame upon rotation of the shaft in a second direction, opposite from the first direction.

12. The wheel assembly of claim 11, further comprising a lever configured to engage the shaft to facilitate at least one of: the rotation of the shaft in the first direction, or the rotation of the shaft in the second direction.

13. The wheel assembly of claim 11, wherein the wheel bracket comprises a first side and a second side, wherein the wheel is located in between the first side and the second side of the wheel bracket, and wherein the first side and the second side of the wheel bracket extend beyond a thickness of the wheel and along respective first and second edges of the first surface, so as to assist in positioning of the wheel along the first surface.

14. The wheel assembly of claim 11, wherein the pin extending through the at least one side of the shaft comprises the pin extending through a first side of the shaft and the pin extending through a second side of the shaft to configure the wheel assembly for at least one of:
capable attachment to either a first side of the solar panel system or a second side of the solar panel system; or
capable attachment to the solar panel system in either a first direction or a second direction.

15. The wheel assembly of claim 11, further comprising a cavity configured to receive a locking pin to secure the wheel assembly to the solar panel system.

16. The wheel assembly of claim 11, wherein the wheel comprises a substantially flat surface for engagement of the first surface, and wherein the wheel assembly further comprises, extending through both the wheel and the wheel bracket to facilitate the rotation of the wheel about the axis, at least one of a bolt, pin, or roller.

17. A method of moving a solar panel system comprising:
attaching a wheel assembly to a first side of a frame supporting a plurality of solar panels;
rotating the wheel assembly in a first direction such that a wheel of the wheel assembly engages a first surface;
continue the rotating of the wheel assembly in the first direction at least until the first side of the frame supporting the plurality of solar panels is lifted;
after the first side of the frame supporting the plurality of solar panels is lifted, applying a locking mechanism to prevent further rotation of the wheel assembly; and
after the applying the locking mechanism, applying a force to move the frame, via rotation of the wheel along the first surface, from a first location to a second location.

18. The method of claim 17, wherein the wheel assembly is a first wheel assembly and the locking mechanism is a first locking mechanism, and wherein the method further comprises:
attaching a second wheel assembly to a second side of the frame supporting the plurality of solar panels;
rotating the second wheel assembly such that a wheel of the second wheel assembly engages a second surface;
continue the rotating of the second wheel assembly at least until the second side of the frame supporting the plurality of solar panels is lifted; and
after the second side of the frame supporting the plurality of solar panels is lifted, applying a second locking mechanism to prevent further rotation of the second wheel assembly,
wherein the applying the force to move the frame from the first location to the second location is after the applying the second locking mechanism, and wherein movement of the frame from the first location to the second location comprises rotation of the wheel of the first wheel assembly along the first surface and rotation of the wheel of the second wheel assembly along the second surface.

19. The method of claim 18, wherein at least one of:
the first surface and the second surface are different portions of a same planar surface; or
the first surface comprises a surface of a first rail via which the wheel of the first wheel assembly is configured to move along, and the second surface comprises a surface of a second rail via which the wheel of the second wheel assembly is configured to move along.

20. The method of claim 17, further comprising:
after movement of the frame from the first location to the second location, disengaging the locking mechanism to enable rotation of the wheel assembly;
rotating the wheel assembly in a second direction, different from the first direction, such that the wheel of the wheel assembly disengages from the first surface;
continuing the rotating of the wheel assembly in the second direction at least until the first side of the frame supporting the plurality of solar panels is lowered; and
after the first side of the frame supported the plurality of solar panels is lowered, removing the wheel assembly from the first side of the frame supporting the plurality of solar panels.
